(19) United States
(12) Patent Application Publication
(10) Pub. No.: US 2026/0192814 A1
(43) Pub. Date: Jul. 9, 2026

(54) DISPLAYING CONTROL DEVICE

(71) Applicant: TOYOTA JIDOSHA KABUSHIKI KAISHA, Toyota-shi, Aichi-ken (JP)

(72) Inventors: Sawa HIGUCHI, Toyota-shi, Aichi-Ken (JP); Ryotarou ARAKI, Chuo-ku, Tokyo (JP)

(73) Assignee: TOYOTA JIDOSHA KABUSHIKI KAISHA, Toyota-shi, Aichi-ken (JP)

(21) Appl. No.: 19/132,521

(22) PCT Filed: Nov. 20, 2023
(86) PCT No.: PCT/JP2023/041674

§ 371 Date: May 23, 2025

(30) Foreign Application Priority Data
Dec. 16, 2022 (JP) 2022-201087

(51) Int. Cl. B60W 50/14; B60W 30/16; B60W 30/18

(52) U.S. Cl. CPC B60W 50/14; B60W 30/16; B60W 30/18072; B60W 2050/146; B60W 2520/10; B60W 2554/802; B60W 2720/106; B60W 2754/30

(57) ABSTRACT

Provided is a displaying control device which can prevent a driver of an own vehicle from having doubts as to whether the own vehicle is accelerated and decelerated appropriately while an automatic driving control is executed. The displaying control device (10) displays an image of a target speed range by the displaying device 30 of the own vehicle during a travel speed control of automatically accelerating or decelerating the own vehicle (100) such that a travel speed of the own vehicle is maintained within the target speed range, or displays an image of a target distance range by the display device during an inter-vehicle distance control of automatically accelerating or decelerating the own vehicle such that an inter-vehicle distance between the own vehicle and a surrounding vehicle (200) around the own vehicle and traveling in the same direction as the own vehicle is maintained within the target distance range.

### TECHNICAL FIELD

The invention relates to a displaying control device.

### BACKGROUND ART

There is known a driving assistance device which performs an automatic driving to automatically drive an own vehicle by automatically controlling acceleration and deceleration of the own vehicle. For example, there is known a driving assistance device which executes a travel speed control to automatically accelerate and decelerate the own vehicle such that a travel speed of the own vehicle is maintained at a target speed, and an inter-vehicle distance control to automatically accelerate and decelerate the own vehicle such that a distance between the own vehicle and a preceding vehicle is maintained at a target distance. There is also known a driving assistance device which displays an image of the target speed on a display while the travel speed control is executed, and displays an image of the target distance while the inter-vehicle distance control is executed (see, for example, Patent Literature 1).

### CITATION LIST

### Patent Literature

PTL 1: JP 2019-196082 A

### SUMMARY OF INVENTION

While the travel speed control is executed, the travel speed of the own vehicle may be controlled with a certain control width for various reasons, and while the inter-vehicle distance control is executed, the distance between the own vehicle and the preceding vehicle may be controlled with a certain control width for various reasons. When the travel speed control or the inter-vehicle distance control is executed in this way, the travel speed of the own vehicle is not maintained at the target speed and fluctuates relatively greatly, or the distance between the own vehicle and the preceding vehicle is not maintained at the target distance and increases or decreases relatively greatly. For this reason, when an automatic driving control such as the travel speed control or the inter-vehicle distance control is executed with a certain control width, if only the image of the target speed is displayed on the display or only the image of the target distance is displayed on the display, a driver of the own vehicle may have doubts about whether the acceleration and deceleration of the own vehicle is being performed appropriately by the automatic driving control.

An object of the present invention is to provide a displaying control device which can prevent the driver of the own vehicle from having doubts about whether the acceleration and deceleration of the own vehicle is being performed appropriately while the automatic driving control is executed.

A displaying control device according to the present invention displays an image of a target speed range by a displaying device of an own vehicle while a travel speed control is executed to automatically accelerate or decelerate the own vehicle such that a travel speed of the own vehicle is maintained within the target speed range, or displays an image of a target distance range by the displaying device while an inter-vehicle distance control is executed to automatically accelerate or decelerate the own vehicle such that an inter-vehicle distance between the own vehicle and a surrounding vehicle which is present around the own vehicle and travels in the same direction as the own vehicle is maintained within the target distance range.

According to the present invention, the image of the target speed range is displayed by the displaying device while the travel speed control is executed.

Therefore, the driver of the own vehicle can easily understand that the travel speed of the own vehicle is controlled within a range having a certain width while the travel speed control is executed. This makes it possible to prevent the driver of the own vehicle from having doubts about whether the acceleration and deceleration of the own vehicle is being performed appropriately while the travel speed control is executed. Similarly, according to the present invention, the image of the target distance range is displayed by the displaying device while the inter-vehicle distance control is executed. Therefore, the driver of the own vehicle can easily understand that the inter-vehicle distance is controlled within a range having a certain width while the inter-vehicle distance control is executed. This makes it possible to prevent the driver of the own vehicle from having doubts about whether the acceleration and deceleration of the vehicle is being performed appropriately while the inter-vehicle distance control is executed.

It should be noted that in the displaying control device according to present invention, the target distance range is, for example, a range defined by an upper limit value which is greater than a target distance by a first value, which target distance is a value obtained by multiplying a target value of the time required for the own vehicle to travel the inter-vehicle distance at the travel speed of the own vehicle, and a lower limit value which is smaller than the target distance by a second value.

According to the present invention, the target distance range is set according to the travel speed of the own vehicle. This makes it possible to control the inter-vehicle distance to a more appropriate distance by the inter-vehicle distance control.

Furthermore, the displaying control device according to the present invention may be configured to, while the travel speed control is executed, display, as the image of the target speed range by the displaying device, an image of a movement range of the own vehicle automatically accelerated or decelerated such that the travel speed of the own vehicle is maintained at a speed within the target speed range.

According to the present invention, the target speed range is expressed in the form of the moving range of the own vehicle. This makes it easier for the driver of the own vehicle to recognize the target speed range.

Furthermore, the displaying control device according to the present invention may be configured to, while the travel speed control is executed, to display, as the image of the target speed range by the displaying device, an image of an upper limit speed and an image of a lower limit speed of the target speed range.

According to the present invention, the target speed range is expressed by the images of its upper and lower speed limits. This makes it easier for the driver of the own vehicle to recognize the target speed range.

Furthermore, the displaying control device according to the present invention may be configured to, when the own vehicle is accelerated by the travel speed control, display, by the displaying device, the image of the upper limit speed and the image of the lower limit speed such that the image of the upper limit speed is highlighted more than the image of the lower limit speed.

According to the present invention, when the own vehicle is accelerated by the travel speed control, the image of the upper speed limit is highlighted. Therefore, even if the travel speed of the own vehicle continues to increase toward the upper speed limit, since the image of the upper speed limit is highlighted, the driver can easily understand that the acceleration and deceleration of the own vehicle is now being intentionally controlled such that the travel speed of the own vehicle increases toward the upper speed limit. This makes it possible to more reliably prevent the driver of the own vehicle from having doubts about whether the acceleration and deceleration of the own vehicle is being performed appropriately while the travel speed control is executed.

Furthermore, the displaying control device according to the present invention may be configured to, when the own vehicle is decelerated by the travel speed control, display, by the displaying device, the image of the upper limit speed and the image of the lower limit speed such that the image of the lower limit speed is highlighted more than the image of the upper limit speed.

According to the present invention, when the vehicle is decelerated by the travel speed control, the image of the lower limit speed is highlighted. Therefore, even if the travel speed of the own vehicle continues to decrease toward the lower limit speed, since the lower limit speed is highlighted, the driver can easily understand that the acceleration and deceleration of the own vehicle is now being intentionally controlled such that the travel speed of the own vehicle decreases toward the lower limit speed. This makes it possible to more reliably prevent the driver of the own vehicle from having doubts about whether the acceleration and deceleration of the own vehicle is being performed appropriately while the travel speed control is executed.

Furthermore, in the displaying control device according to the present invention, the travel speed control is, for example, a control of accelerating the own vehicle by operating a driving device of the own vehicle such that an energy efficiency of the driving device is maintained at or above a predetermined efficiency, and decelerating the own vehicle by operating the driving device such that the own vehicle coasts.

According to the present invention, the travel speed control can be executed with high energy efficiency.

Furthermore, the displaying control device according to the present invention may be configured to, while the inter-vehicle distance control is executed, display, as the image of the target distance range by the displaying device, an image of an upper limit distance and an image of a lower limit distance of the target distance range.

According to the present invention, the target distance range is expressed by the images of its upper and lower limit distances. This makes it easier for the driver of the own vehicle to recognize the target distance range.

Furthermore, the displaying control device according to the present invention may be configured to, when the own vehicle is accelerated by the inter-vehicle distance control, display the image of the upper limit distance and the image of the lower limit distance by the displaying device such that the image of the lower limit distance is highlighted more than the image of the upper limit distance.

According to the present invention, when the vehicle is accelerated by the inter-vehicle distance control, the image of the lower limit distance is highlighted. Therefore, even if the inter-vehicle distance continues to decrease toward the lower limit distance, since the lower limit distance is highlighted, the driver can easily understand that the acceleration and deceleration of the own vehicle is now being intentionally controlled such that the inter-vehicle distance decreases toward the lower limit distance. This makes it possible to more reliably prevent the driver of the own vehicle from having doubts about whether the acceleration and deceleration of the own vehicle is being performed appropriately while inter-vehicle distance control is executed.

Furthermore, the displaying control device according to the present invention may be configured to, when the own vehicle is decelerated by the inter-vehicle distance control, display the image of the upper limit distance and the image of the lower limit distance by the displaying device such that the image of the upper limit distance is highlighted more than the image of the lower limit distance.

According to the present invention, when the own vehicle is decelerated by the inter-vehicle distance control, the image of the upper limit distance is highlighted. Therefore, even if the inter-vehicle distance continues to increase toward the upper limit distance, since the image of the upper limit distance is highlighted, the driver can easily understand that the acceleration and deceleration of the own vehicle is now being intentionally controlled such that the inter-vehicle distance increases toward the upper limit distance. Therefore, it is possible to more reliably prevent the driver of the own vehicle from having doubts about whether the acceleration and deceleration of the own vehicle is being performed appropriately while the inter-vehicle distance control is executed.

Furthermore, in the displaying control device according to the present invention claim 1, the inter-vehicle distance control is, for example, a control of accelerating the own vehicle by operating a driving device of the own vehicle such that an energy efficiency of the driving device is maintained at or above a predetermined efficiency, and decelerating the own vehicle by controlling an operation of the driving device such that the own vehicle coasts.

According to the present invention, the inter-vehicle distance control can be performed with high energy efficiency.

Furthermore, the displaying control device according to the present invention may be configured to display, by the displaying device, an image of a current travel speed of the own vehicle on the image of the target speed range displayed by the displaying device while the travel speed control is executed, and display, by the displaying device, an image of the surrounding vehicle on the image of the target distance range displayed by the displaying device while the inter-vehicle distance control is executed.

According to the present invention, the image of the current travel speed of the own vehicle is displayed on the image of the target speed range while the travel speed control is executed. Therefore, the driver of the own vehicle can easily understand a relationship between the current travel speed of the own vehicle and the target speed range.

Furthermore, the displaying control device according to the present invention may be configured to, while the inter-vehicle distance control is executed, display, by the displaying device, the image of the surrounding vehicle such that a position of the image of the surrounding vehicle corresponds to an actual position of the surrounding vehicle relative to the own vehicle on the image of the target distance range displayed by the displaying device.

According to the present invention, the image representing the surrounding vehicle is displayed on the image of the target distance range such that the position of the image representing the surrounding vehicle corresponds to the actual position of the surrounding vehicle relative to the own vehicle while the inter-vehicle distance control is executed. Therefore, the driver of the own vehicle can easily understand the relationship between the surrounding vehicle and the target distance range.

Furthermore, in the displaying control device according to the present invention, the displaying device is, for example, a device which displays images on a windshield of the own vehicle. In this case, the displaying control device according to the present invention may be configured to, when the surrounding vehicle is a preceding vehicle traveling in front of the own vehicle, display the image of the target distance range on the windshield by the displaying device such that a positional relationship between the image of the target distance range displayed by the displaying device and the preceding vehicle corresponds to an actual positional relationship between the target distance range and the preceding vehicle while the inter-vehicle distance control is executed.

According to the present invention, while the inter-vehicle distance control is executed, the image of the target distance range is displayed such that the positional relationship between the image of target distance range and the preceding vehicle corresponds to the actual positional relationship between the target distance range and the preceding vehicle. This makes it easier for the driver of the own vehicle to understand the relationship between the preceding vehicle and the target distance range.

Furthermore, the displaying control device according to the present invention may be configured to when the own vehicle is accelerated by the travel speed control, display an image of an upper limit speed and an image of a lower limit speed by the displaying device such that the image of the upper limit speed is highlighted more than the image of the lower limit speed, when the own vehicle is decelerated by the travel speed control, display the image of the upper limit speed and the image of the lower limit speed by the displaying device such that the image of the lower limit speed is highlighted more than the image of the upper limit speed, when the own vehicle is accelerated by the inter-vehicle distance control, display an image of an upper limit distance and an image of a lower limit distance by the displaying device such that the image of the lower limit distance is highlighted more than the image of the upper limit distance, when the own vehicle is decelerated by the inter-vehicle distance control, display the image of the upper limit distance and the image of the lower limit distance by the displaying device such that the image of the upper limit distance is highlighted more than the image of the lower limit distance. In this case, the displaying control device according to the present invention may be configured to when the displaying control device cannot determine whether the own vehicle is accelerated or decelerated while the travel speed control is executed, not highlight the image of the upper limit speed nor the image of the lower limit speed, and when the displaying control device cannot determine whether the own vehicle is accelerated or decelerated while the inter-vehicle distance control is executed, not highlight the image of the upper limit distance nor the image of the lower limit distance.

According to the present invention, while the travel speed control is executed, when it is not possible to determine whether the own vehicle is accelerated or decelerated, the images of the upper limit speed and the lower limit speed are not highlighted. This makes it possible to prevent the driver of the own vehicle from being provided with erroneous information on an acceleration/deceleration state of the own vehicle. Also, while the inter-vehicle distance control is executed, when it is not possible to determine whether the own vehicle is accelerated or decelerated, the images of the upper limit distance and the lower limit distance are not highlighted. This makes it possible to prevent the driver of the own vehicle from being provided with erroneous information on the acceleration/deceleration state of the own vehicle.

Furthermore, in the displaying control device according to the present invention, the target speed range and the target distance range can be changed by an operator of the own vehicle.

According to the present invention, the operator of the own vehicle can arbitrarily set the target speed range and the target distance range.

The components of the present invention are not limited to the embodiments of the present invention described below with reference to the drawings. Other objects, other features, and associated advantages of the present invention will be easily understood from the description of the embodiments of the present invention.

### BRIEF DESCRIPTION OF DRAWINGS

FIG. 1 is a diagram showing a control device including a displaying control device according to an embodiment of the present invention.

FIG. 2A is a diagram showing a scene in which a travel speed control is executed.

FIG. 2B is a diagram showing a scene in which an inter-vehicle distance control is executed.

FIG. 3 is a diagram showing a relationship between an engine output power and an energy efficiency of an internal combustion engine, and a relationship between a motor output power and an energy efficiency of an electric motor.

FIG. 4A is a diagram showing a scene in which the travel speed control is executed when a following vehicle is present.

FIG. 4B is a diagram showing a scene in which the inter-vehicle distance control is executed when the following vehicle is present.

FIG. 5A is a diagram showing a head-up display when a first travel speed control is executed.

FIG. 5B is a diagram showing a meter display when the first travel speed control is executed.

FIG. 5C is a diagram showing an enlarged portion of the meter display shown in FIG. 5B.

FIG. 6A is a diagram showing the head-up display when a first inter-vehicle distance control is executed.

FIG. 6B is a diagram showing the meter display when the first inter-vehicle distance control is executed.

FIG. 6C is a diagram showing an enlarged portion of the meter display shown in FIG. 6B.

FIG. 7A is a diagram showing the head-up display when an own vehicle is decelerated by a coasting deceleration control while a second travel speed control is executed.

FIG. 7B is a diagram showing the head-up display when the own vehicle is decelerated by coasting deceleration control and a travel speed of the own vehicle has decreased to a lower limit speed while the second travel speed control is executed.

FIG. 7C is a diagram showing the head-up display when the own vehicle is accelerated by an optimal acceleration control while the second travel speed control is executed.

FIG. 7D is a diagram showing the head-up display when the own vehicle is accelerated by the optimal acceleration control and the travel speed of the own vehicle has increased to an upper limit speed while the second travel speed control is executed.

FIG. 8 is a diagram showing the meter display when the second travel speed control is executed.

FIG. 9A is a diagram showing a part of the meter display when the own vehicle is decelerated by the coasting deceleration control while the second travel speed control is executed.

FIG. 9B is a diagram showing a part of the meter display when the own vehicle is decelerated by the coasting deceleration control and the travel speed of the own vehicle has decreased to the lower limit speed while the second travel speed control is executed.

FIG. 9C is a diagram showing a part of the meter display when the own vehicle is accelerated by the optimal acceleration control while the second travel speed control is executed.

FIG. 9D is a diagram showing a part of the meter display when the own vehicle is accelerated by the optimal acceleration control and the travel speed of the own vehicle has increased to the upper limit speed while the second travel speed control is executed.

FIG. 10A is a diagram showing the head-up display when the own vehicle is decelerated by the coasting deceleration control when a second inter-vehicle distance control is executed.

FIG. 10B is a diagram showing the head-up display when the own vehicle is decelerated by the coasting deceleration control and a preceding vehicle distance has increased to an upper limit distance when the second inter-vehicle distance control is executed.

FIG. 10C is a diagram showing the head-up display when the own vehicle is accelerated by the optimal acceleration control when the second inter-vehicle distance control is executed.

FIG. 10D is a diagram showing the head-up display when the own vehicle is accelerated by the optimal acceleration control and the preceding vehicle distance has decreased to a lower limit distance when the second inter-vehicle distance control is executed.

FIG. 11 is a diagram showing an image of a target distance range displayed by the head-up display when the second inter-vehicle distance control is executed.

FIG. 12 is a diagram showing the meter display when the second inter-vehicle distance control is executed.

FIG. 13A is a diagram showing a part of the meter display when the own vehicle is decelerated by the coasting deceleration control when the second inter-vehicle distance control is executed.

FIG. 13B is a diagram showing a part of the meter display when the own vehicle is decelerated by the coasting deceleration control and the preceding vehicle distance has increased to the upper limit distance when the second inter-vehicle distance control is executed.

FIG. 13C is a diagram showing a part of the meter display when the own vehicle is accelerated by the optimal acceleration control while the second inter-vehicle distance control is executed.

FIG. 13D is a diagram showing a part of the meter display when the own vehicle is accelerated by the optimal acceleration control and the preceding vehicle distance has decreased to the lower limit distance while the second inter-vehicle distance control is executed.

FIG. 14 is a diagram showing the image of the target distance range displayed on the meter display when the second inter-vehicle distance control is executed.

FIG. 15 is a diagram showing the control device according to a first modified example of the embodiment of the present invention.

FIG. 16 is a diagram showing the control device according to a second modified example of the embodiment of the present invention.

FIG. 17 is a flowchart showing a routine executed by the control device according to the embodiment of the present invention.

FIG. 18 is a flowchart showing a routine executed by the control device according to the embodiment of the present invention.

### DESCRIPTION OF EMBODIMENTS

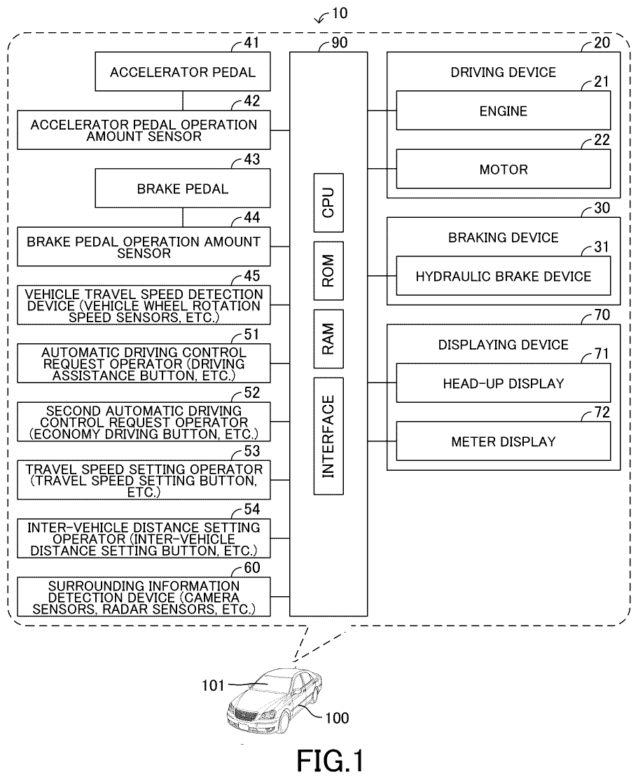

Below, a displaying control device according to an embodiment of the present invention will be described with reference to the drawings. Below, the control device 10 will be described taking as an example a case where an operator of an own vehicle 100 is a person who gets on the own vehicle 100 and drives the own vehicle 100 (i.e., a driver of the own vehicle 100). Therefore, in this embodiment, the control device 10 is mounted on the own vehicle 100 as shown in FIG. 1.

However, the operator of the own vehicle 100 may be a person who drives the own vehicle 100 remotely without getting on the own vehicle 100 (i.e., a remote operator of the own vehicle 100). When the operator of the own vehicle 100 is the remote operator, the control device 10 is mounted on the own vehicle 100 and on a remote operation facility installed outside the own vehicle 100 to remotely drive the own vehicle 100, respectively, and functions of the control device 10 described below are shared between the control device 10 mounted on the own vehicle 100 and the control device 10 mounted on the remote operation facility.

The control device 10 functions as a displaying control device according to the embodiment of the present invention, and also functions as a vehicle driving control device which controls a driving of the own vehicle 100, etc. The control device 10 is equipped with an ECU 90.

The ECU 90 is an electronic control unit. The ECU 90 has a microcomputer as its main component. The microcomputer includes a CPU, a ROM, a RAM, a non-volatile memory, an interface, and the like. The CPU is configured to realize various functions by executing instructions, programs, or routines stored in the ROM. In this embodiment, the control device 10 has one ECU, but as described below, it may also be configured to have multiple ECUs and have the ECUs share various processes described below.

The ECU 90 is electrically connected to a driving device 20, a braking device 30, an accelerator pedal operation amount sensor 42, a brake pedal operation amount sensor 44, a vehicle travel speed detection device 45, an automatic driving control request operator 51, a second automatic driving control request operator 52, a surrounding information detection device 60, and a displaying device 70.

### <Automatic Driving Control>

The control device 10 executes an automatic driving control of automatically controlling the driving of the own vehicle 100. In this embodiment, the control device 10 executes an automatic driving control of automatically controlling acceleration and deceleration of the own vehicle 100 as the automatic driving control of automatically controlling the driving of the own vehicle 100.

In this embodiment, the automatic driving control includes a first automatic driving control and a second automatic driving control. The first automatic driving control includes a first travel speed control (or a constant speed automatic driving control) and a first inter-vehicle distance control (or a following automatic driving control), and the second automatic driving control includes a second travel speed control (or an economy travel speed control) and a second inter-vehicle distance control (or an economy following automatic driving control).

It should be noted that the control device 10 can control the acceleration and deceleration of the own vehicle 100 by controlling operations of the driving device 20 and/or the braking device 30. The driving device 20 includes an internal combustion engine 21 and an electric motor 22. The braking device 30 includes a hydraulic brake device 31.

### <First Travel Speed Control>

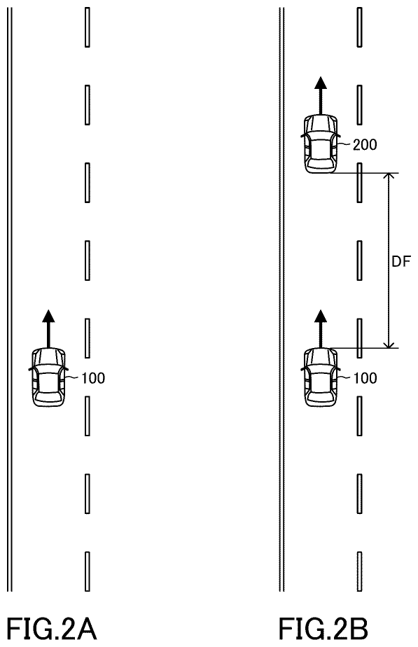

The first travel speed control is a control of automatically controlling the acceleration and deceleration of the own vehicle 100 such that a travel speed (or an own vehicle speed V) of the own vehicle 100 is maintained at a target speed Vtgt. The first travel speed control is executed when an automatic driving control request condition is satisfied and a second automatic driving control request condition is not satisfied, and there is no preceding vehicle as shown in FIG. 2A.

The preceding vehicle is a vehicle traveling in an own vehicle travel lane ahead of the own vehicle 100 and is present within a predetermined distance from the own vehicle 100. The own vehicle travel lane is a lane in which the own vehicle 100 is traveling.

In this embodiment, the control device 10 determines whether or not the preceding vehicle is present based on information (or surrounding detection information IS) acquired by the surrounding information detection device 60. The surrounding information detection device 60 is a device which detects information on the surroundings of the own vehicle 100, and is equipped with, for example, camera sensors and radar sensors.

Furthermore, the control device 10 acquires the own vehicle speed V by the vehicle travel speed detection device 45. The vehicle travel speed detection device 45 is a device which acquires information on the own vehicle speed V, and is equipped with, for example, vehicle wheel rotation speed sensors installed on each wheel of the own vehicle 100.

The automatic driving control request condition is a condition that the execution of automatic driving control is requested. The driver of the own vehicle 100 can request the control device 10 to execute the automatic driving control by operating an automatic driving control request operator 51 such as a driving assistance button. The control device 10 determines that the execution of the automatic driving control is requested when the automatic driving control request operator 51 is operated while the automatic driving control is not executed, and thereafter determines that the execution of the automatic driving control is requested unless the automatic driving control request operator 51 is operated. On the other hand, the control device 10 determines that the execution of the automatic driving control is not requested when the automatic driving control request operator 51 is operated while the automatic driving control is executed.

The second automatic driving control request condition is a condition that the execution of the second automatic driving control is requested. The driver of the own vehicle 100 can request the control device 10 to execute the second automatic driving control by operating a second automatic driving control request operator 52 (or an economy automatic driving control request operator) such as an economy driving button. When the second automatic driving control request operator 52 is operated while the second automatic driving control is not executed, the control device 10 determines that the execution of the second automatic driving control is requested, and thereafter determines that the execution of the second automatic driving control is requested unless the second automatic driving control request operator 52 is operated. On the other hand, when the second automatic driving control request operator 52 is operated while the second automatic driving control is executed, the control device 10 determines that execution of the second automatic driving control is not requested.

While the first travel speed control is executed, when the own vehicle speed V becomes smaller than the target speed Vtgt, the control device 10 accelerates the own vehicle 100, and when the own vehicle speed V becomes greater than the target speed Vtgt, the control device 10 decelerates the own vehicle 100.

It should be noted that the control device 10 sets the target speed Vtgt to a speed set by the driver of the own vehicle 100 as a target of the travel speed of the own vehicle 100. The driver of the own vehicle 100 can arbitrarily set the target of the travel speed (i.e., the target speed Vtgt) of the own vehicle 100 by operating a travel speed setting operator 53 such as a travel speed setting button. Alternatively, the control device 10 sets the target speed Vtgt to the own vehicle speed V at the time when the automatic driving control request operator 51 is operated and the automatic driving control request condition becomes satisfied.

### <First Inter-Vehicle Distance Control>

The first inter-vehicle distance control is a control of automatically controlling the acceleration and deceleration of the own vehicle 100 such that a preceding vehicle distance DF is maintained at a target distance Dtgt. The first inter-vehicle distance control is executed when the automatic driving control request condition is satisfied and the second automatic driving control request condition is not satisfied, and the preceding vehicle 200 is present as shown in FIG. 2B.

The preceding vehicle distance DF is a distance between the own vehicle 100 and the preceding vehicle 200 as shown in FIG. 2B. In this embodiment, the control device 10 acquires the preceding vehicle distance DF based on the information acquired by the surrounding information detection device 60 (i.e., the surrounding detection information IS).

While the first inter-vehicle distance control is executed, the control device 10 accelerates the own vehicle 100 when the preceding vehicle distance DF becomes greater than the target distance Dtgt, and decelerates the own vehicle 100 when the preceding vehicle distance DF becomes smaller than the target distance Dtgt.

It should be noted that the control device 10 may set the preceding vehicle distance DF set by the driver as the target distance Dtgt as is, but in this embodiment, the target distance Dtgt is set based on the preceding vehicle distance DF set by the driver of the own vehicle 100.

More specifically, the control device 10 sets an inter-vehicle time T calculated based on the preceding vehicle distance DF set by the driver as a target inter-vehicle time Ttgt. The inter-vehicle time T is a time required for the own vehicle 100 to travel the preceding vehicle distance DF, and is specifically a value obtained by dividing the preceding vehicle distance DF by the own vehicle speed V (T=DF/V). Therefore, the target inter-vehicle time Ttgt is a target value of the time required for the own vehicle 100 to travel the preceding vehicle distance DF, and in this embodiment, the target inter-vehicle time Ttgt is a value obtained by dividing the preceding vehicle distance DF (or a target preceding vehicle distance DFtgt) set by the driver of the own vehicle 100 by the own vehicle speed V (Ttgt=DFtgt/V). The greater the preceding vehicle distance DF, the greater the inter-vehicle time T.

The control device 10 sets a value obtained by multiplying the set target inter-vehicle time Ttgt by the own vehicle speed V at that time as the target distance Dtgt.

It should be noted that the driver can arbitrarily set the preceding vehicle distance DF (i.e., the target preceding vehicle distance DFtgt) by operating an inter-vehicle distance setting operator 54 such as an inter-vehicle distance setting button. In this embodiment, the driver can arbitrarily set the preceding vehicle distance DF from one of a long distance, a medium distance, and a short distance.

The control device 10 may be configured to set the target inter-vehicle time Ttgt to the inter-vehicle time T corresponding to the preceding vehicle distance DF at the time when the automatic driving control request operator 51 is operated and the automatic driving control request condition becomes satisfied.

### <Second Travel Speed Control>

The second travel speed control is a control of automatically controlling the acceleration and deceleration of the own vehicle 100 such that the own vehicle speed V is maintained within a target speed range RVtgt. The second travel speed control is executed when the automatic driving control request condition is satisfied and the second automatic driving control request condition is satisfied, and there is no preceding vehicle as shown in FIG. 2A.

The target speed range RVtgt is a range which is set to include the target speed Vtgt, and in this embodiment, the target speed range RVtgt is a range which has an upper limit (or an upper limit speed Vupper) which is higher than the target speed Vtgt by a predetermined value (or an upper limit speed setting value ΔVupper), and a lower limit (or a lower limit speed Vlower) which is lower than the target speed Vtgt by a predetermined value (or a lower limit speed setting value ΔVlower). The upper limit speed setting value ΔVupper and the lower limit speed setting value ΔVlower may be the same value or different values.

It should be noted that the driver can set the target speed range RVtgt as desired by operating the travel speed setting operator 53.

While the second travel speed control is executed, the control device 10 accelerates the own vehicle 100 when the own vehicle speed V becomes smaller than the lower limit speed Vlower, and decelerates the own vehicle 100 when the own vehicle speed V becomes greater than the upper limit speed Vupper.

When the control device 10 accelerates the own vehicle 100 while the second travel speed control is executed, the control device 10 accelerates the own vehicle 100 by an optimal acceleration control, and when the control device 10 decelerates the own vehicle 100 while the second travel speed control is executed, the control device 10 decelerates the own vehicle 100 by a coasting deceleration control.

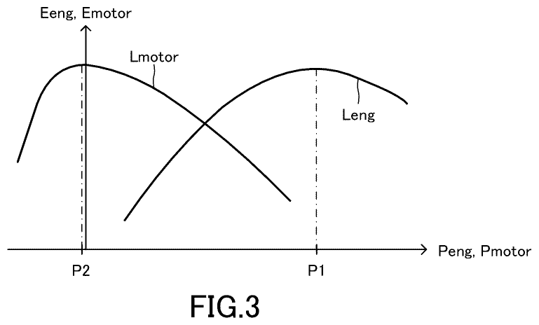

The optimal acceleration control is a control of accelerating the own vehicle 100 by controlling operations of the internal combustion engine 21 and the electric motor 22 such that an energy efficiency of the driving device 20 is maintained at or above a predetermined efficiency, and in this embodiment, the optimal acceleration control is a control of accelerating the own vehicle 100 by controlling the operations of the internal combustion engine 21 and the electric motor 22 such that the energy efficiency of the driving device 20 is maximized (or at least extremely close to the maximized efficiency). For example, when a relationship between an engine output power Peng and an energy efficiency Eeng of the internal combustion engine 21 is as shown by a line Leng in FIG. 3, and a relationship between a motor output power Pmotor and an energy efficiency Eeng of the electric motor 22 is as shown by a line Lmotor in FIG. 3, the control device 10 operates the internal combustion engine 21 at an operating point (or an optimum operating point) where the energy efficiency Eeng of the internal combustion engine 21 is at its maximum efficiency. It should be noted that the operating point is a point determined by a rotation speed (or the number of revolutions) of the internal combustion engine 21 and a load of the internal combustion engine 21. The engine output power Peng is a power output by the internal combustion engine 21, and the motor output power Pmotor is a power output by the electric motor 22.

When the internal combustion engine 21 is operated at the optimal operating point, its energy efficiency Eeng is at its highest value (or a maximum efficiency), and the engine output power Peng is a value corresponding to the maximum efficiency (or an optimum engine output power P1) in the example shown in FIG. 3. It should be noted that in FIG. 3, a reference symbol P2 is a value of the motor output power when the energy efficiency Emotor of the electric motor 22 is the highest.

The coasting deceleration control is a control of controlling the operation of the driving device 20, i.e., the operations of the internal combustion engine 21 and the electric motor 22, such that the own vehicle 100 coasts. According to the coasting deceleration control, the own vehicle 100 is decelerated mainly by air resistance and road resistance. Therefore, it can also be said that the coasting deceleration control is control of controlling the operation of the driving device 20, i.e., the operations of the internal combustion engine 21 and the electric motor 22, such that the own vehicle 100 is decelerated mainly by the air resistance and the road resistance.

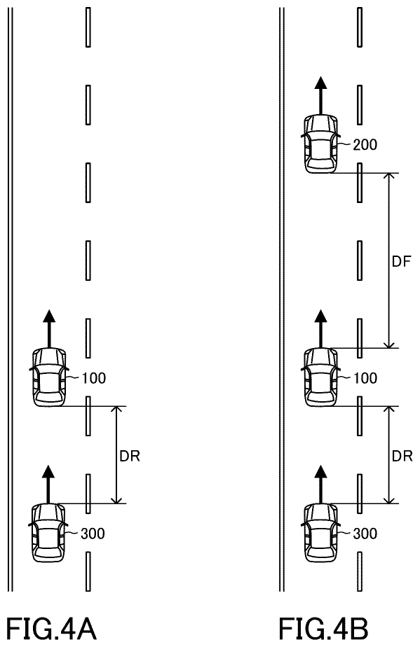

It should be noted that as shown in FIG. 4A, when a following vehicle 300 is present, the control device 10 may be configured to accelerate the own vehicle 100 by the optimal acceleration control when a distance between the own vehicle 100 and the following vehicle 300 (or a following vehicle distance DR) becomes equal to or less than a predetermined distance (or a predetermined following vehicle distance DRth) even when the own vehicle speed V is greater than the lower limit speed Vlower while the second travel speed control is executed. In this case, the control device 10 continues the optimal acceleration control until the own vehicle speed V reaches the upper limit speed Vupper, even if the following vehicle distance DR becomes greater than the predetermined following vehicle distance DRth after starting the optimal acceleration control.

When the following vehicle 300 is present, the control device 10 may be configured to determine a timing to start the optimal acceleration control while the second travel speed control is executed, taking into consideration a difference between the own vehicle speed V and a travel speed of the following vehicle 300, such that the own vehicle 100 does not get too close to the following vehicle 300.

It should be noted that the following vehicle 300 is a vehicle traveling in the own vehicle travel lane behind the own vehicle 100, and is within a predetermined distance from the own vehicle 100.

### <Second Vehicle Distance Control>

The second inter-vehicle distance control is a control of automatically controlling the acceleration and deceleration of the own vehicle 100 such that the preceding vehicle distance DF is maintained within a target distance range RDtgt. The second inter-vehicle distance control is executed when the automatic driving control request condition is satisfied and the second automatic driving control request condition is satisfied, and the preceding vehicle 200 is present as shown in FIG. 2B.

The target distance range RDtgt is a range which is set to include the target distance Dtgt, and in this embodiment, the target distance range RDtgt is a range which has an upper limit (or an upper limit distance Dupper) which is greater than the target distance Dtgt by a predetermined value (or an upper limit distance setting value ΔDupper), and a lower limit (or a lower limit distance Dlower) which is smaller than the target distance Dtgt by a predetermined value (or a lower limit distance setting value ΔDlower). In other words, the target distance range RDtgt is a range which has an upper limit which is greater than the target distance Dtgt, which is a target value of the time required for the own vehicle 100 to travel the preceding vehicle distance DF multiplied by the travel speed of the own vehicle 100, by a first value (i.e., the upper limit distance setting value ΔDupper), and a lower limit which is smaller than the target distance Dtgt by a second value (i.e., the lower limit distance setting value ΔDlower). It should be noted that the upper limit distance setting value ΔDupper and the lower limit distance setting value ΔDlower may be the same value or different values.

It should be noted that the driver can arbitrarily set the target distance range RDtgt by operating the inter-vehicle distance setting operator 54.

While the second inter-vehicle distance control is executed, the control device 10 accelerates the own vehicle 100 when the preceding vehicle distance DF becomes greater than the upper limit distance Dupper, and decelerates the own vehicle 100 when the preceding vehicle distance DF becomes smaller than the lower limit distance Dlower.

When the control device 10 accelerates the own vehicle 100 while the second inter-vehicle distance control is executed, the control device 10 accelerates the own vehicle 100 by the optimal acceleration control, and when the control device 10 decelerates the own vehicle 100 while the second inter-vehicle distance control is executed, the control device 10 decelerates the own vehicle 100 by the coasting deceleration control.

It should be noted that, as shown in FIG. 4B, when the following vehicle 300 is present, the control device 10 may be configured to accelerate the own vehicle 100 by the optimal acceleration control when the following vehicle distance DR becomes equal to or less than a predetermined following vehicle distance DRth, even if the preceding vehicle distance DF is smaller than the upper limit distance Dupper, while the second inter-vehicle distance control is executed. In this case, after starting the optimal acceleration control, the control device 10 continues the optimal acceleration control until the preceding vehicle distance DF reaches the lower limit distance Dlower, even if the following vehicle distance DR becomes greater than the predetermined following vehicle distance DRth.

Furthermore, when the following vehicle 300 is present, the control device 10 may be configured to determine a timing to start the optimal acceleration control such that the own vehicle 100 does not get too close to the following vehicle 300 while the second inter-vehicle distance control is executed, taking into account the difference between the own vehicle speed V and the travel speed of the following vehicle 300.

It should be noted that when the automatic driving control request condition is not satisfied, the control device 10 calculates a required driving force (or a required driving torque) based on an operation amount of an accelerator pedal 41 acquired by the accelerator pedal operation amount sensor 42 and the own vehicle speed V, and controls the operation of the driving device 20 such that a driving force equivalent to the required driving force is applied from the driving device 20 to the own vehicle 100. In addition, when the automatic driving control request condition is not satisfied, the control device 10 calculates a required braking force (or a required braking torque) based on an operation amount of a brake pedal 43 obtained by the brake pedal operation amount sensor 44, and controls the operation of the braking device 30 such that a braking force equivalent to the required braking force is applied to the own vehicle 100 by the braking device 30.

### <Display of Control-Related Information>

Furthermore, while the automatic driving control is executed, the control device 10 displays information (control-related information) by the displaying device 70 regarding the travel speed of the own vehicle 100, which is the subject to be controlled by the automatic driving control, and/or the distance between the own vehicle 100 and the preceding vehicle 200.

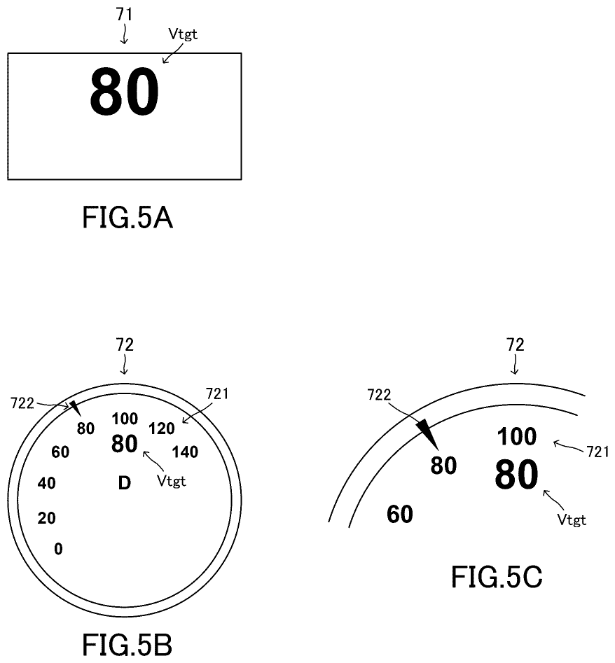

In this embodiment, the displaying device 70 includes a head-up display 71 and a meter display 72. The head-up display 71 is a device which provides various information to the driver of the own vehicle 100 by projecting various images onto a windshield 101 of the own vehicle 100 (see, for example, FIG. 5A). The meter display 72 is disposed in front of a driver's seat of the own vehicle 100, and is a device which provides various information to the driver of the own vehicle 100 by displaying various images. In this embodiment, the meter display 72 displays images of a speedometer 721 and a speed indicator 722 during its activation (see, for example, FIG. 5B). The speed indicator 722 indicates the current travel speed of the own vehicle 100, and is displayed at a position on the image of the speedometer 721 which corresponds to the current travel speed of the own vehicle 100.

### <During First Travel Speed Control>

While the first travel speed control is executed, the control device 10 displays an image of the target speed Vtgt by the head-up display 71 as shown in FIG. 5A. Furthermore, while the first travel speed control is executed, the control device 10 displays the image of the target speed Vtgt by the meter display 72 as shown in FIG. 5B and FIG. 5C. FIG. 5C shows an enlarged portion of the meter display 72 shown in FIG. 5B.

It should be noted that FIG. 5A to FIG. 5C show an example in which the target speed Vtgt is 80 kilometers per hour.

### <During First Inter-vehicle Distance Control>

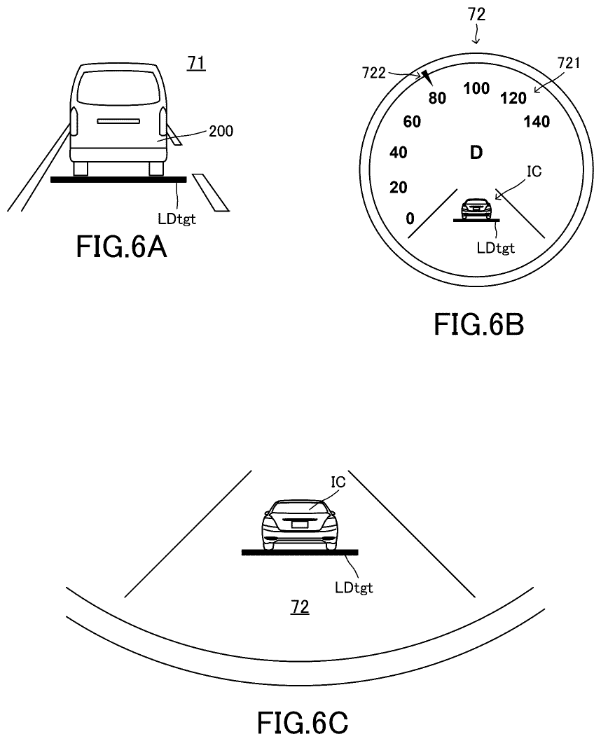

Meanwhile, while the first inter-vehicle distance control is executed, the control device 10 displays an image of a target distance line LDtgt by the head-up display 71 as shown in FIG. 6A. The image of the target distance line LDtgt is a line-shaped image indicating a position which is located the target distance Dtgt ahead the own vehicle 100. While the first inter-vehicle distance control is executed, the preceding vehicle distance DF is controlled to the target distance Dtgt, so the image of the target distance line LDtgt is displayed near rear wheels of the preceding vehicle 200.

Furthermore, while the first inter-vehicle distance control is executed, the control device 10 displays an image of a target distance line LDtgt and an image of a vehicle icon IC by the meter display 72 as shown in FIG. 6B and FIG. 6C. The image of the target distance line LDtgt is a line-shaped image indicating the position of the target distance Dtgt. The image of the vehicle icon IC is an image representing the preceding vehicle 200. While the first inter-vehicle distance control is executed, the preceding vehicle distance DF is controlled to the target distance Dtgt, so the image of the target distance line LDtgt is displayed near rear wheels of the vehicle icon IC. It should be noted that FIG. 6C shows an enlarged portion of the meter display 72 shown in FIG. 6B.

### <During Second Automatic Driving Control>

As described above, while the second travel speed control is executed, the own vehicle speed V is controlled to be within the target speed range RVtgt. Therefore, the own vehicle speed V fluctuates relatively greatly around the target speed Vtgt. For this reason, the driver may have doubts about whether the own vehicle speed V is appropriately controlled by the automatic driving control, i.e., whether the own vehicle 100 is accelerated or decelerated appropriately. Similarly, while the second inter-vehicle distance control is executed, the preceding vehicle distance DF is controlled to be within the target distance range RDtgt. Therefore, the preceding vehicle distance DF increases or decreases relatively greatly around the target distance Dtgt. For this reason, the driver may have doubts about whether the preceding vehicle distance DF is appropriately controlled by the automatic driving control, i.e., whether the own vehicle 100 is accelerated or decelerated appropriately.

### <During Second Travel Speed Control>

Therefore, while the second travel speed control is executed, the control device 10 displays images of the control-related information by the head-up display 71 and the meter display 72 as follows.

### <During Coasting Deceleration Control>

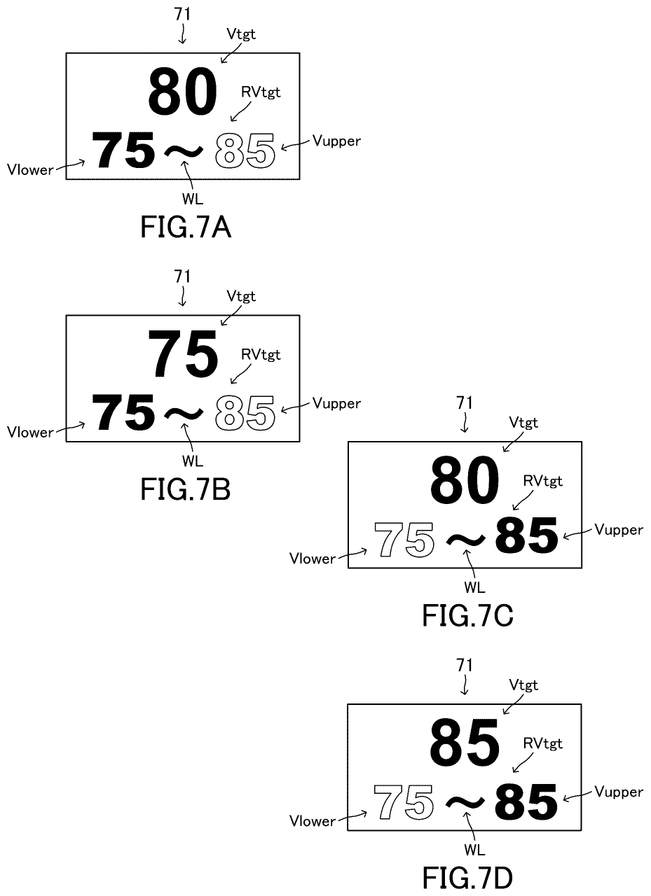

When the control device 10 executes the coasting deceleration control while the second travel speed control is executed, the control device 10 displays the image of the target speed Vtgt by the head-up display 71 and displays the image of the target speed range RVtgt below the image of the target speed Vtgt as shown in FIG. 7A. In this embodiment, the control device 10 displays the images of the lower limit speed Vlower, the upper limit speed Vupper, and a wavy line WL as the target speed range RVtgt. In this embodiment, the image of the lower limit speed Vlower is displayed on the left side of the image of the wavy line WL, and the image of the upper limit speed Vupper is displayed on the right side of the image of the wavy line WL.

It should be noted that FIG. 7A to FIG. 7D show an example in which the target speed Vtgt is 80 kilometers per hour, the lower limit speed Vlower is 75 kilometers per hour, and the upper limit speed Vupper is 85 kilometers per hour.

Furthermore, when the control device 10 executes the coasting deceleration control while the second travel speed control is executed, the control device 10 displays the image of the lower limit speed Vlower in a highlighted or prominent manner. In other words, the control device 10 displays the image of the lower limit speed Vlower and the image of the upper limit speed Vupper such that the ease of recognition of the image of the lower limit speed Vlower (i.e., the ease of recognition of the image of the lower limit speed Vlower) is higher than the ease of recognition of the image of the upper limit speed Vupper (i.e., the ease of recognition of the image of the upper limit speed Vupper).

The ease of recognition of the image is an index value (or an ease-of-recognition index value) which indicates the ease with which a person can recognize the content of the image. The higher the ease of recognition of the image, the easier it is for a person to recognize the content of the image.

In this embodiment, the control device 10 displays the image of the upper limit speed Vupper using numbers with only outlines, and displays the image of the lower limit speed Vlower using numbers that show the entire image rather than numbers with only outlines, thereby making the ease of recognition of the image of the lower limit speed Vlower higher than the ease of recognition of the image of the upper limit speed Vupper. In this way, the control device 10 changes the ease of recognition of the image by changing the design of the image.

It should be noted that the ease of recognition of the image also varies depending on the brightness and size of the image. In general, the higher the brightness of the image, the higher the ease of recognition of the image, and the larger the image, the higher the ease of recognition of the image. Therefore, the control device 10 may be configured to make the ease of recognition of the image of the lower limit speed Vlower higher than the ease of recognition of the image of the upper limit speed Vupper by making the brightness of the image of the lower limit speed Vlower higher than the brightness of the image of the upper limit speed Vupper, or by making the size of the image of the lower limit speed Vlower greater than the size of the image of the upper limit speed Vupper.

Furthermore, the ease of recognition of the image varies depending on its colors. For example, a red image is more easily recognizable than a white image. Accordingly, the control device 10 may be configured to display the image of the lower limit speed Vlower in red and the image of the upper limit speed Vupper in white, thereby making the lower limit speed Vlower more easily recognizable than the upper limit speed Vupper.

Furthermore, the ease of recognition of the image also varies depending on the lighting mode of the image. In general, an image is more easily recognizable when it is displayed by blinking than when it is displayed by continuously lighting. Accordingly, the control device 10 may be configured to display the image of the lower limit speed Vlower in a blinking manner and the image of the upper limit speed Vupper in a continuously lighting manner, thereby making the ease of recognition of the image of the lower limit speed Vlower higher than the ease of recognition of the image of the upper limit speed Vupper.

Further, the ease of recognition of the image can be increased by surrounding the image with a line drawing, placing a line drawing around the image, or by underlining the image. Thus, the control device 10 may be configured to make the ease of recognition of the image of the lower limit speed Vlower higher than the ease of recognition of the image of the upper limit speed Vupper by displaying the image of the lower limit speed Vlower by placing a line image (i.e., an image representing a line) around the image of the lower limit speed Vlower and displaying the image of the upper limit speed Vupper without placing a line image around the image of the upper limit speed Vupper, or by displaying the image of the lower limit speed Vlower by placing a line image below the image of the lower limit speed Vlower and displaying the image of the upper limit speed Vupper without placing a line image below the image of the upper limit speed Vupper.

In addition, in this embodiment, the control device 10 displays the image of the lower limit speed Vlower and the image of the upper limit speed Vupper such that the ease of recognition of the image of the lower limit speed Vlower is the same as the normal ease of recognition and the ease of recognition of the image of the upper limit speed Vupper is lower than the normal ease of recognition, thereby making the ease of recognition of the image of the lower limit speed Vlower higher than the ease of recognition of the image of the upper limit speed Vupper.

However, the control device 10 may display the image of the lower limit speed Vlower and the image of the upper limit speed Vupper such that the ease of recognition of the image of the lower limit speed Vlower is higher than the normal ease of recognition and the ease of recognition of the image of the upper limit speed Vupper is the same as the normal ease of recognition, thereby making the ease of recognition of the image of the lower limit speed Vlower higher than the ease of recognition of the image of the upper limit speed Vupper.

Alternatively, the control device 10 may display the image of the lower limit speed Vlower and the image of the upper limit speed Vupper such that the ease of recognition of the image of the lower limit speed Vlower is higher than the normal ease of recognition and the ease of recognition of the image of the upper limit speed Vupper is lower than the normal ease of recognition, thereby making the ease of recognition of the image of the lower limit speed Vlower higher than the ease of recognition of the image of the upper limit speed Vupper.

It should be noted that the normal ease of recognition is the ease of recognition of the image of the target speed Vtgt displayed as an image by the head-up display 71 while the first travel speed control is executed (i.e., the ease of recognition of the image of the target speed Vtgt).

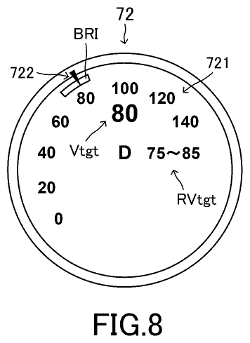

Furthermore, while the second travel speed control is executed, the control device 10 provides the driver with the control-related information through the meter display 72 as shown in FIG. 8.

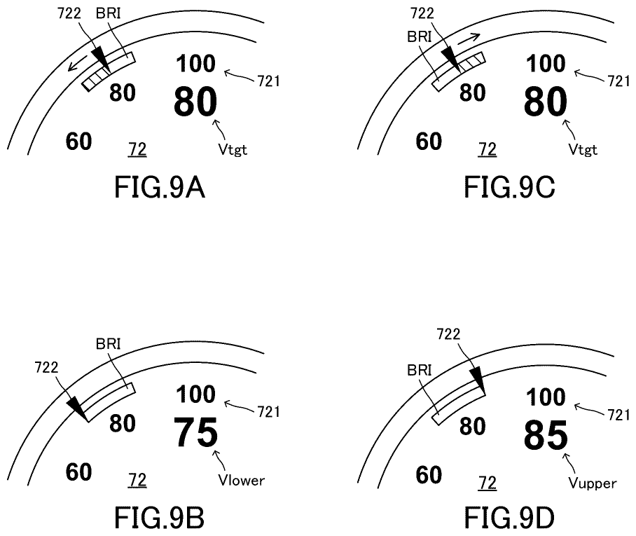

Specifically, when the coasting deceleration control is executed while the second travel speed control is executed, the control device 10 displays an image of a target speed range bar BRV near the speedometer 721 by the meter display 72 as shown in FIG. 9A. Furthermore, the control device 10 displays the image of the target speed Vtgt by the meter display 72, and displays the image of the target speed range RVtgt below the image of the target speed Vtgt.

It should be noted that FIGS. 9A to 9D also show an example in which the target speed Vtgt is 80 kilometers per hour, the lower limit speed Vlower is 75 kilometers per hour, and the upper limit speed Vupper is 85 kilometers per hour.

In this embodiment, the image of the target speed range bar BRV is displayed extending from a position corresponding to the position of the speedometer 721 indicating 75 kilometers per hour to a position corresponding to the position of the speedometer 721 indicating 85 kilometers per hour. Therefore, while the second travel speed control is executed, the image of the target speed range bar BRV is displayed at a position overlapping with the speed indicator 722. Therefore, while the second travel speed control is executed, the control device 10 displays, by the meter display 72 (i.e., the displaying device 70), the image of the current driving speed of the own vehicle 100 (i.e., the current own vehicle speed V) on the image of the target speed range bar BRV (i.e., the image of the target speed range RVtgt) displayed by the meter display 72 (i.e., the displaying device 70).

Furthermore, the control device 10 displays the image of the target speed range bar BRV by highlighting or making the portion of the image of the target speed range bar BRV on the image of the lower limit speed Vlower side stand out. In other words, the control device 10 displays the image of the target speed range bar BRV such that the ease of recognition of the image of the portion of the image of the target speed range bar BRV on the image of the lower limit speed Vlower side is higher than the ease of recognition of the image of the portion of the image of the target speed range bar BRV on the upper limit speed Vupper side.

In this embodiment, the control device 10 displays the image of the target speed range bar BRV with the brightness of the portion of the image of the target speed range bar BRV on the lower limit speed Vlower side of the speed indicator 722 higher than the brightness of the portion of the image of the target speed range bar BRV on the upper limit speed Vupper side of the speed indicator 722, thereby making the ease of recognition of the image of the portion of the image of the target speed range bar BRV on the lower limit speed Vlower side higher than the ease of recognition of the image of the portion of the image of the target speed range bar BRV on the upper limit speed Vupper side.

It should be noted that the control device 10 may be configured to display the image of the target speed range RVtgt by the meter display 72 by highlighting or make the image of the lower limit speed Vlower stand out, similar to the image of the target speed range RVtgt displayed by the head-up display 71.

### <Reaching Lower Limit Speed>

Furthermore, when the own vehicle speed V decreases to the lower limit speed Vlower while the second travel speed control is executed, the control device 10 displays the image of the lower limit speed Vlower and displays the image of the target speed range RVtgt below the image of the lower limit speed Vlower by the head-up display 71 as shown in FIG. 7B. At this time, the image of the target speed range RVtgt is displayed by highlighting or making the image of the lower limit speed Vlower stand out, similar to the image of the target speed range RVtgt displayed by the head-up display 71 while the coasting deceleration control is executed.

Furthermore, when the own vehicle speed V decreases to the lower limit speed Vlower while the second travel speed control is executed, the control device 10 displays the image of the lower limit speed Vlower, displays the image of the target speed range RVtgt below the image of the lower limit speed Vlower, and displays the image of the target speed range bar BRV near the image of the speedometer 721 by the meter display 72 as shown in FIG. 9B. It should be noted that at this time, the image of the speed indicator 722 has moved to the position of the image of the lower limit speed Vlower on the image of the target speed range bar BRV.

### <During Optimal Acceleration Control>

Furthermore, when the control device 10 executes the optimal acceleration control while the second travel speed control is executed, the control device 10 displays the image of the target speed Vtgt by the head-up display 71 and displays the image of the target speed range RVtgt below the image of the target speed Vtgt by the head-up display 71 as shown in FIG. 7C.

Furthermore, when the control device 10 executes the optimal acceleration control while the control device 10 executes the second travel speed control, the control device 10 displays the image of the upper limit speed Vupper by highlighting or making the image of the upper limit speed Vupper stand out. In other words, the control device 10 displays the image of the lower limit speed Vlower and the image of the upper limit speed Vupper such that the ease of recognition of the image of the upper limit speed Vupper is higher than the ease of recognition of the image of the lower limit speed Vlower.

In this embodiment, the control device 10 displays the image of the lower limit speed Vlower using numbers with only outlines, and displays the image of the upper limit speed Vupper using numbers that show the entire image rather than numbers with only the outline, thereby making the ease of recognition of the image of the upper limit speed Vupper higher than the ease of recognition of the image of the lower limit speed Vlower.

It should be noted that in this embodiment, the control device 10 displays the image of the upper limit speed Vupper and the image of the lower limit speed Vlower such that the ease of recognition of the image of the upper limit speed Vupper is the same as the normal ease of recognition and the ease of recognition of the image of the lower limit speed Vlower is lower than the normal ease of recognition, thereby making the ease of recognition of the image of the upper limit speed Vupper higher than the image of the lower limit speed Vlower.

However, the control device 10 may display the image of the upper limit speed Vupper and the image of the lower limit speed Vlower such that the ease of recognition of the image of the upper limit speed Vupper is higher than the normal ease of recognition and the ease of recognition of the image of the lower limit speed Vlower is the same as the normal ease of recognition, thereby making the ease of recognition of the image of the upper limit speed Vupper higher than the ease of recognition of the image of the lower limit speed Vlower.

Alternatively, the control device 10 may display the image of the upper limit speed Vupper and the image of the lower limit speed Vlower such that the ease of recognition of the image of the upper limit speed Vupper is higher than the normal ease of recognition and the ease of recognition of the image of the lower limit speed Vlower is lower than the normal ease of recognition, thereby making the ease of recognition of the image of the upper limit speed Vupper higher than the ease of recognition of the image of the lower limit speed Vlower.

Furthermore, when the control device 10 executes the optimal acceleration control while the second travel speed control is executed, the control device 10 displays the image of the target speed Vtgt by the meter display 72, displays the image of the target speed range RVtgt below the image of the target speed Vtgt, and displays the image of the target speed range bar BRV near the image of the speedometer 721 as shown in FIG. 9C.

At this time, the control device 10 displays the image of the target speed range bar BRV by highlighting or making the portion of the image of the target speed range bar BRV on the upper limit speed Vupper side stand out. In other words, the control device 10 displays the image of the target speed range bar BRV such that the ease of recognition of the image of the portion of the image of the target speed range bar BRV on the upper limit speed Vupper side is higher than the ease of recognition of the image of the portion of the image of the target speed range bar BRV on the lower limit speed Vlower side.

In this embodiment, the control device 10 displays the image of the target speed range bar BRV with the brightness of the portion of the image of the target speed range bar BRV on the upper limit speed Vupper side of the speed indicator 722 higher than the brightness of the portion of the image of the target speed range bar BRV on the lower limit speed Vlower side of the speed indicator 722, thereby making the ease of recognition of the image of the portion of the image of the target speed range bar BRV on the upper limit speed Vupper side higher than the ease of recognition of the image of the portion of the image of the target speed range bar BRV on the lower limit speed Vlower side.

It should be noted that the control device 10 may be configured to display the image of the target speed range RVtgt by the meter display 72 by highlighting or making the image of the upper limit speed Vupper stand out, similar to the image of the target speed range RVtgt displayed by the head-up display 71.

### <Reaching Upper Limit Speed>

Furthermore, when the own vehicle speed V increases to the upper limit speed Vupper while the second travel speed control is executed, the control device 10 displays the image of the upper limit speed Vupper and displays the image of the target speed range RVtgt below the image of the upper limit speed Vupper by the head-up display 71 as shown in FIG. 7D. At this time, the image of the target speed range RVtgt is displayed by highlighting or making the image of the upper limit speed Vupper stand out, similar to the image of the target speed range RVtgt displayed by the head-up display 71 while the optimal acceleration control is executed.

Furthermore, when the own vehicle speed V increases to the upper limit speed Vupper while the second travel speed control is executed, the control device 10 displays the image of the upper limit speed Vupper, displays the image of the target speed range RVtgt below the image of the upper limit speed Vupper, and displays the image of the target speed range bar BRV near the image of the speedometer 721 by the meter display 72 as shown in FIG. 9D. It should be noted that at this time, the image of the speed indicator 722 has moved to the position of the image of the upper limit speed Vupper on the target speed range bar BRV.

### <During Second Inter-Vehicle Distance Control>

Furthermore, while the second inter-vehicle distance control is executed, the control device 10 displays control-related information by the head-up display 71 and by the meter display 72, as follows.

### <During Coasting Deceleration Control>

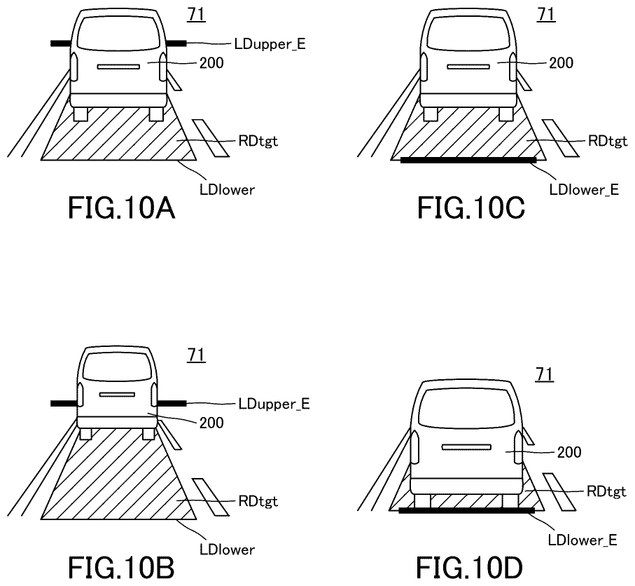

Furthermore, when the control device 10 executes the coasting deceleration control while the second inter-vehicle distance control is executed, the control device 10 displays the image of the target distance range RDtgt and an image of an upper distance highlighting line LDupper_E by the head-up display 71 as shown FIG. 10A.

It should be noted that while the second inter-vehicle distance control is executed, the control device 10 displays the image of the target distance range RDtgt on the windshield 101 by the head-up display 71 (i.e., the displaying device 70) such that the positional relationship between the image of the target distance range RDtgt and the image of the preceding vehicle 200 displayed by the head-up display 71 (i.e., the displaying device 70) corresponds to the actual positional relationship between the target distance range RDtgt and the preceding vehicle 200. Therefore, the image of the target distance range RDtgt is displayed so as to overlap with the preceding vehicle 200.

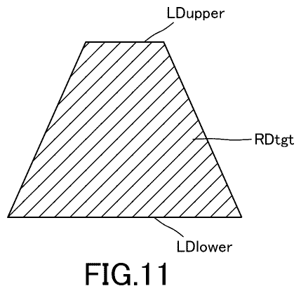

As shown in FIG. 11, the image of the target distance range RDtgt is displayed as a trapezoid image. In the image of the target distance range RDtgt, its upper outline (i.e., an upper limit distance line LDupper) is displayed showing a position which is located the upper limit distance Dupper ahead the own vehicle 100, and its lower outline (i.e., a lower limit distance line LDlower) is displayed showing a position which is located the lower limit distance Dlower ahead the own vehicle 100.

Furthermore, the image of the upper limit distance highlighting line LDupper_E represents a position which is located the upper limit distance Dupper ahead the own vehicle 100. Therefore, the image of the upper limit distance highlighting line LDupper_E is displayed on the image of the upper limit distance line LDupper of the image of the target distance range RDtgt. In this embodiment, the image of the upper limit distance highlighting line LDupper_E is a thicker image than the image of the upper limit distance line LDupper.

Therefore, when the control device 10 executes the coasting deceleration control while the second inter-vehicle distance control is executed, the control device 10 displays the image of the upper limit distance line LDupper in a highlighted or prominent manner. In other words, the control device 10 displays the image of the upper limit distance Dupper and the image of the lower limit distance Dlower such that the ease of recognition of the image of the upper limit distance Dupper (i.e., the ease of recognition of the image representing the upper limit distance Dupper) is higher than the ease of recognition of the image of the lower limit distance Dlower (i.e., the ease of recognition of the image representing the lower limit distance Dlower).

In this way, in this embodiment, the control device 10 makes the ease of recognition of the image of the upper limit distance Dupper higher than the ease of recognition of the image of the lower limit distance Dlower by displaying the image of the upper limit distance line LDupper by the head-up display 71 with a thicker image than the image of the lower limit distance line LDlower.

It should be noted that the ease of recognition of the image changes depending on the design of the image. Therefore, the control device 10 may be configured to make the ease of recognition of the image of the upper limit distance Dupper higher than the ease of recognition of the image of the lower limit distance Dlower by making the design of the image of the upper limit distance line LDupper different from the design of the image of the lower limit distance line LDlower.

Furthermore, the ease of recognition of the image varies depending on the brightness of the image. In general, the higher the brightness of the image, the higher the ease of recognition of the image. Therefore, the control device 10 may be configured to make the ease of recognition of the image of the upper limit distance Dupper higher than the ease of recognition of the image of the lower limit distance Dlower by making the brightness of the image of the upper limit distance line LDupper higher than the brightness of the image of the lower limit distance line LDlower.

Furthermore, the ease of recognition of the image varies depending on its colors. For example, the ease of recognition of a red image is higher than the ease of recognition of a black image. Therefore, the control device 10 may be configured to display the image of the upper limit distance line LDupper in red and the image of the lower limit distance line LDlower in black, thereby making the ease of recognition of the image of the upper limit distance Dupper higher than the ease of recognition of the image of the lower limit distance Dlower.

Furthermore, the ease of recognition of the image also varies depending on the lighting mode of the image. In general, an image is more easily recognizable when it is displayed by blinking than when it is displayed by continuously lighting. Accordingly, the control device 10 may be configured to display the image of the upper limit distance line LDupper in a blinking manner and the image of the lower limit distance line LDlower in a continuously lighting manner, thereby making the ease of recognition of the image of the upper limit distance Dupper higher than the ease of recognition of the image of the lower limit distance Dlower.

It should be noted that while the coasting deceleration control of the second inter-vehicle distance control is executed, the control device 10 displays the image of the upper distance line LDupper in a highlighted or prominent manner as shown in FIG. 10B until the preceding vehicle distance DF reaches the upper distance Dupper and the optimal acceleration control is started.

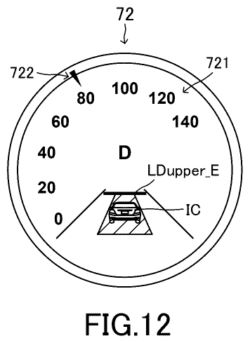

Furthermore, while the second inter-vehicle distance control is executed, the control device 10 provides the driver with the control-related information through the meter display 72 as shown in FIG. 12.

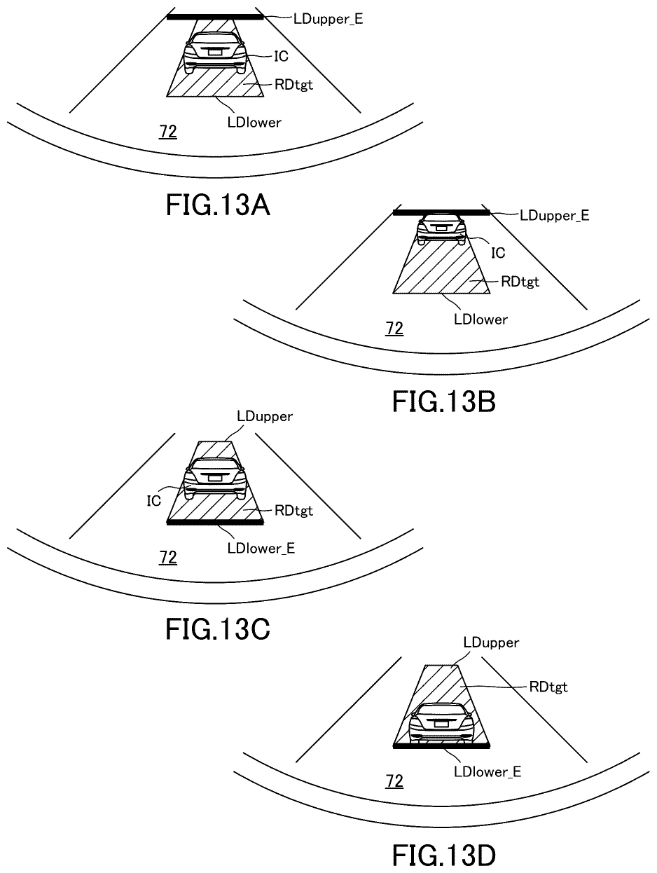

Specifically, when the coasting deceleration control is executed while the second inter-vehicle distance control is executed, the control device 10 displays the image of the target distance range RDtgt and the image of the upper distance highlighting line LDupper_E by the meter display 72 as shown in FIG. 13A. Furthermore, the control device 10 displays the image of the vehicle icon IC by the meter display 72.

The vehicle icon IC is an image representing the preceding vehicle 200. Furthermore, the image of the target distance range RDtgt is displayed so as to overlap with the image of the vehicle icon IC. Therefore, while the second inter-vehicle distance control is executed, the control device 10 displays, by the meter display 72 (i.e., the displaying device 70), the image of the vehicle icon IC (i.e., an image representing the preceding vehicle 200) on the image of the target distance range RDtgt displayed by the meter display 72 (i.e., the displaying device 70).

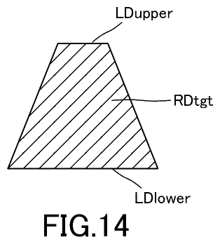

As shown in FIG. 14, the image of the target distance range RDtgt is displayed as a trapezoidal image. In the image of the target distance range RDtgt, its upper outline (i.e., the upper limit distance line LDupper) represents the position of the upper limit distance Dupper, and the lower outline (i.e., the lower limit distance line LDlower) represents the position of the lower limit distance Dlower.

Furthermore, the image of the upper limit distance highlighting line LDupper_E represents the position of the upper limit distance Dupper. Therefore, the image of the upper limit distance highlighting line LDupper_E is displayed on the image of the upper limit distance line LDupper of the target distance range RDtgt. In this embodiment, the image of the upper limit distance highlighting line LDupper_E is a thicker image than the image of the upper limit distance line LDupper.

Therefore, when the control device 10 executes the coasting deceleration control while the second inter-vehicle distance control is executed, the control device 10 displays the image of the upper limit distance line LDupper in a highlighted or prominent manner. In other words, the control device 10 displays the image of the upper limit distance Dupper and the image of the lower limit distance Dlower such that the ease of recognition of the image of the upper limit distance Dupper (i.e., the ease of recognition of the image representing the upper limit distance Dupper) is higher than the ease of recognition of the image of the lower limit distance Dlower (i.e., the ease of recognition of the image representing the lower limit distance Dlower).

In this way, in this embodiment, the control device 10 makes the ease of recognition of the image of the upper limit distance Dupper higher than the ease of recognition of the image of the lower limit distance Dlower by displaying the image of the upper limit distance line LDupper by the meter display 72 with a thicker image than the image of the lower limit distance line LDlower.

It should be noted that while the coasting deceleration control of the second inter-vehicle distance control is executed, the control device 10 displays the image of the upper limit distance line LDupper in a highlighted or prominent image as shown in FIG. 10D until the preceding vehicle distance DF reaches the upper limit distance Dupper and the optimal acceleration control is started.

### <During Optimal Acceleration Control>

Meanwhile, while the control device 10 executes the optimal acceleration control while the second inter-vehicle distance control is executed, the control device 10 displays the image of the target distance range RDtgt by the head-up display 71 and displays the image of the lower limit distance highlighting line LDlower_E by the head-up display 71 as shown in FIG. 10C.

The image of the target distance range RDtgt is displayed so as to overlap with the preceding vehicle 200. Furthermore, the image of the lower limit distance highlighting line LDlower_E indicates a position which is located the lower limit distance Dlower ahead the own vehicle 100. Therefore, the image of the lower limit distance highlighting line LDlower_E is displayed on the image of the lower limit distance line LDlower of the image of the target distance range RDtgt. In this embodiment, the image of the lower limit distance highlighting line LDlower_E is thicker than the image of the lower limit distance line LDlower.

Therefore, when the control device 10 executes the optimal acceleration control while the second inter-vehicle distance control is executed, the control device 10 displays the image of the lower limit distance line LDlower in a highlighted or prominent manner. In other words, the control device 10 displays the image of the lower limit distance Dlower and the image of the upper limit distance Dupper such that the ease of recognition of the image of the lower limit distance Dlower (i.e., the ease of recognition of the image representing the lower limit distance Dlower) is higher than the ease of recognition of the image of the upper limit distance Dupper (i.e., the ease of recognition of the image representing the upper limit distance Dupper).

In this way, in this embodiment, the control device 10 makes the ease of recognition of the image of the lower limit distance Dlower higher than the ease of recognition of the image of the upper limit distance Dupper by displaying the image of the lower limit distance line LDlower by the head-up display 71 with a thicker line than the image of the upper limit distance line LDupper.

It should be noted that while the optimal acceleration control of the second inter-vehicle distance control is executed, the control device 10 displays the image of the lower limit distance line LDlower in a highlighted or prominent manner as shown in FIG. 10D until the preceding vehicle distance DF reaches the lower limit distance Dlower and the coasting deceleration control is started.

Furthermore, when the control device 10 executes the optimal acceleration control while the second inter-vehicle distance control is executed, the control device 10 displays the image of the vehicle icon IC, the image of the target distance range RDtgt, and the image of the lower limit distance highlighting line LDlower_E by the meter display 72 as shown in FIG. 13C.

Again, the image of the target distance range RDtgt is displayed so as to overlap with the image of the vehicle icon IC. Furthermore, the image of the lower limit distance highlighting line LDlower_E is displayed on the image of the upper limit distance line LDupper of the target distance range RDtgt.

Therefore, when the control device 10 executes the optimal acceleration control while the second inter-vehicle distance control is executed, the control device 10 displays the image of the lower limit distance line LDlower in a highlighted or prominent manner. In other words, the control device 10 displays the image of the lower limit distance Dlower and the image of the upper limit distance Dupper such that the ease of recognition of the image of the lower limit distance Dlower (i.e., the ease of recognition of the image representing the lower limit distance Dlower) is higher than the ease of recognition of the image of the upper limit distance Dupper (i.e., the ease of recognition of the image representing the upper limit distance Dupper).

In this way, in this embodiment, the control device 10 makes the ease of recognition of the image of the lower limit distance Dlower higher than the ease of recognition of the image of the upper limit distance Dupper by displaying the image of the lower limit distance line LDlower by the meter display 72 in a thicker image than the image of the upper limit distance line LDupper.

It should be noted that while the optimal acceleration control of the second inter-vehicle distance control is executed, the control device 10 displays the image of the lower limit distance line LDlower in a highlighted or prominent manner as shown in FIG. 13D until the preceding vehicle distance DF reaches the lower limit distance Dlower and the coasting deceleration control is started.

It should be noted that while the second inter-vehicle distance control is executed, the control device 10 displays the image of the vehicle icon IC (i.e. the image representing the preceding vehicle 200) by the meter display 72 (i.e., the displaying device 70) such that the position of the image of the vehicle icon IC (i.e., the image representing the preceding vehicle 200) on the image of the target distance range RDtgt displayed by the meter display 72 (i.e., the displaying device 70) corresponds to the actual position of the preceding vehicle 200 relative to the own vehicle 100.

### <Effects>

According to the control device 10, while the second travel speed control is executed, the image of the target speed range RVtgt is displayed by the head-up display 71 and the meter display 72. Therefore, the driver can easily understand that the own vehicle speed V is controlled within a certain range. This makes it possible to prevent the driver from having doubts about whether the own vehicle 100 is accelerated or decelerated appropriately by the automatic driving control.

Similarly, according to the control device 10, while the second inter-vehicle distance control is executed, the image of the target distance range RDtgt is displayed by the head-up display 71 and the meter display 72. Therefore, the driver can easily understand that the preceding vehicle distance DF is controlled within a certain range. This makes it possible to prevent the driver from having doubts about whether the own vehicle 100 is accelerated or decelerated appropriately by the automatic driving control.

Furthermore, according to the control device 10, when the coasting deceleration control is executed while the second travel speed control is executed, the image of the lower limit speed Vlower is displayed in a highlighted manner, and when the optimal acceleration control is executed while the second travel speed control is executed, the image of the upper limit speed Vupper is displayed in a highlighted manner. Therefore, even if the own vehicle speed V continues to decrease beyond the target speed Vtgt, since the image of the lower limit speed Vlower is highlighted, the driver can easily understand that the acceleration and deceleration of the own vehicle 100 is now intentionally controlled such that the own vehicle speed V decreases toward the lower limit speed Vlower. Furthermore, even if the own vehicle speed V continues to increase beyond the target speed Vtgt, since the image of the upper limit speed Vupper is highlighted, the driver can easily understand that the acceleration and deceleration of the own vehicle 100 is now intentionally controlled such that the own vehicle speed V increases toward the upper limit speed Vupper. This makes it possible to more reliably prevent the driver from having doubts about whether the own vehicle 100 is accelerated and decelerated appropriately by the automatic driving control.

Similarly, according to the control device 10, when the coasting deceleration control is executed while the second inter-vehicle distance control is executed, the image of the upper limit distance Dupper is displayed in a highlighted manner, and when the optimal acceleration control is executed while the second inter-vehicle distance control is executed, the image of the lower limit distance Dlower is displayed in a highlighted manner. Therefore, even if the preceding vehicle distance DF continues to increase beyond the target distance Dtgt, since the image of the upper limit distance Dupper is highlighted, the driver can easily understand that the acceleration and deceleration of the own vehicle 100 is now intentionally controlled such that the preceding vehicle distance DF increases toward the upper limit distance Dupper. Furthermore, even if the preceding vehicle distance DF continues to decrease beyond the target distance Dtgt, since the image of the lower limit distance Dlower is highlighted, the driver can easily understand that the acceleration and deceleration of the own vehicle 100 is now intentionally controlled such that the preceding vehicle distance DF decreases toward the lower limit distance Dlower. This makes it possible to more reliably prevent the driver from having doubts about whether the own vehicle 100 is accelerated and decelerated appropriately by the automatic driving control.

It should be noted that while the automatic driving control is executed, the control device 10 displays the images of the control-related information by both the head-up display 71 and the meter display 72, but may be configured to display the images of the control-related information by either the head-up display 71 or the meter display 72.

Furthermore, while the second travel speed control is executed, the control device 10 may be configured to display the image of the target speed range RVtgt by the displaying device 70 in a similar form to the image of the target distance range RDtgt. That is, while the second travel speed control is executed, the control device 10 may be configured to display the image of the target speed range RVtgt by the displaying device 70 in a similar form to the displaying form shown in FIG. 10 and FIG. 13.

In this case, while the second travel speed control is executed, the control device 10 displays, by the displaying device 70, an image of a movement range of the own vehicle 100 (i.e., an own vehicle movement range) when the own vehicle 100 is automatically accelerated or decelerated such that the own vehicle speed V is maintained at a speed within the target speed range RVtgt, as the image of the target speed range RVtgt. In this case, a line of the image of the own vehicle movement range corresponding to the image of the upper limit distance line LDupper of the image of the target distance range RDtgt is a line representing the upper limit speed Vupper (i.e., an upper limit speed line), and a line of the own vehicle movement range corresponding to the image of the lower limit distance line LDlower of the image of the target distance range RDtgt is a line representing the lower limit speed Vlower (i.e., a lower limit speed line).

Furthermore, in this case, the control device 10 displays the image of the target speed range RVtgt by the head-up display 71 such that the image of the upper limit speed line of the image of the target speed range RVtgt moves away from the own vehicle 100 while the coasting control of the second travel speed control is executed, and displays the image of the target speed range RVtgt by the head-up display 71 such that the image of the upper limit speed line of the image of the target speed range RVtgt moves closer to the own vehicle 100 while the optimal acceleration control of the second travel speed control is executed. In addition, at this time, the control device 10 may display an image of a line similar to the image of the lower limit distance highlighting line LDlower_E on the image of the lower limit speed line of the image of the target speed range RVtgt by the head-up display 71 while the coasting control of the second travel speed control is executed, and may display an image of a line similar to the image of the upper limit distance line LDupper on the image of the upper limit speed line of the image of the target speed range RVtgt while the optimal acceleration control of the second travel speed control is executed.

Furthermore, in this case, the control device 10 displays the image of the vehicle icon IC as an image representing the own vehicle 100 by the meter display 72 while the second travel speed control is executed, and the control device 10 displays the image of the target speed range RVtgt by the meter display 72 such that the image of the upper speed line of the target speed range RVtgt moves away from the image of the vehicle icon IC while the coasting control of the second travel speed control is executed, and the control device 10 displays the image of the target speed range RVtgt by the meter display 72 such that the image of the upper speed line of the image of the target speed range RVtgt moves closer to the image of the vehicle icon IC while the optimal acceleration control of the second travel speed control is executed. In addition, at this time, the control device 10 may display an image of a line similar to the image of the lower limit distance highlighting line LDlower_E on the image of the lower limit speed line of the image of the target speed range RVtgt by the meter display 72 while the coasting control of the second travel speed control is executed, and may display an image of a line similar to the image of the upper limit distance line LDupper on the image of the upper limit speed line of the image of the target speed range RVtgt by the meter display 72 while the optimal acceleration control of the second travel speed control is executed.

In addition, the present invention is not limited to the above embodiment, and various modified examples can be adopted within the scope of the present invention.

### First Modified Example

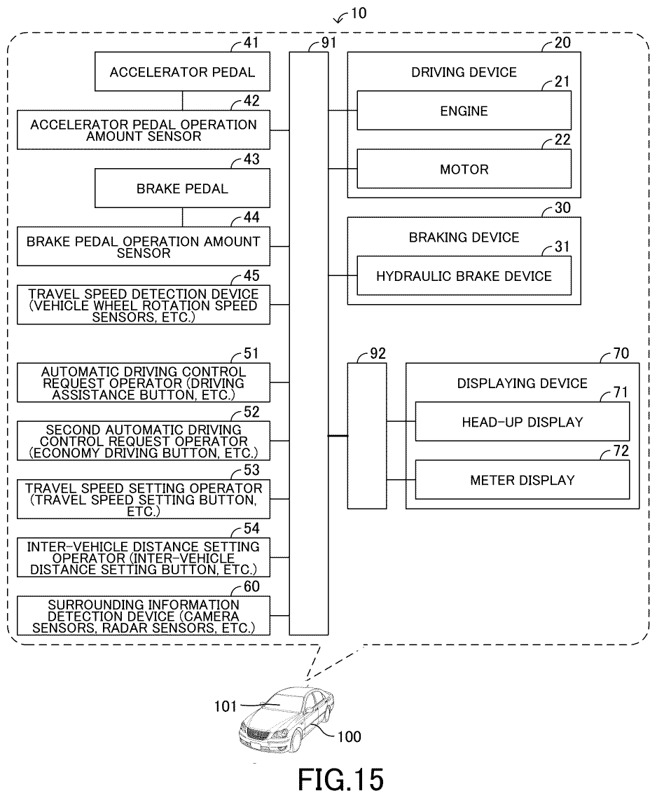

For example, as a first modified example of the embodiment of the present invention, as shown in FIG. 15, the control device 10 may have two ECUs, i.e., a first ECU 91 (or an ACC control ECU) and a second ECU 92 (or a meter ECU), instead of the ECU 90.

In an example shown in FIG. 15, the first ECU 91 is electrically connected to the driving device 20, the braking device 30, the accelerator pedal operation amount sensor 42, the brake pedal operation amount sensor 44, the vehicle travel speed detection device 45, the automatic driving control request operator 51, the second automatic driving control request operator 52, and the surrounding information detection device 60. On the other hand, the second ECU 92 is electrically connected to the displaying device 70.

Then, while the automatic driving control is executed, the first ECU 91 provides the second ECU 92 with information on the current own vehicle speed V, whether or not the preceding vehicle 200 is present, whether the optimal acceleration control or the coasting deceleration control is executed, the upper limit speed Vupper, the lower limit speed Vlower, the upper limit distance Dupper, and the lower limit distance Dlower.

While the automatic driving control is executed, the second ECU 92 displays the images of the target speed range RVtgt and the target distance range RDtgt, etc. by the head-up display 71 and the meter display 72 based on the above information provided by the first ECU 91 as described above.

### Second Modified Example

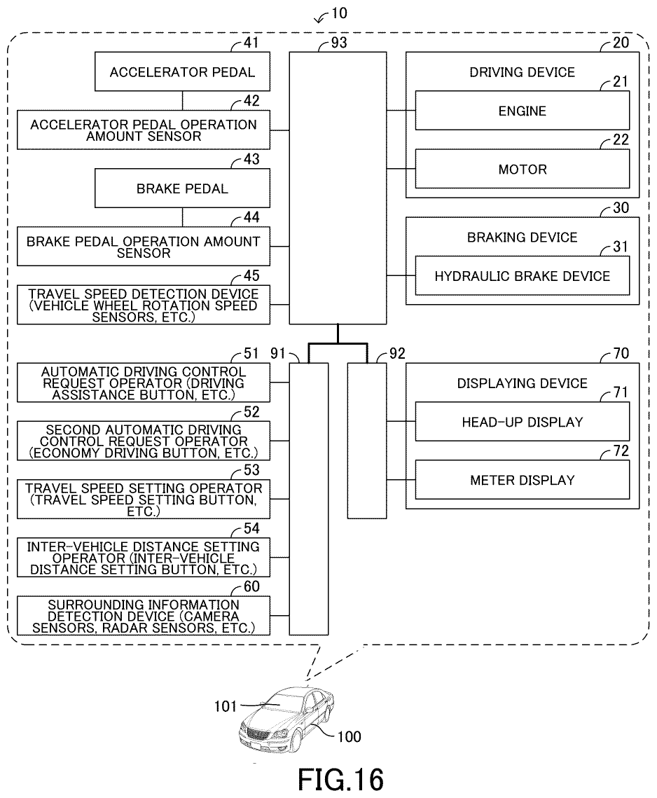

Alternatively, as a second modified example of the embodiment of the present invention, as shown in FIG. 16, the control device 10 may have three ECUs, namely, the first ECU 91 (or the ACC control ECU), the second ECU 92 (or the meter ECU), and a third ECU 93 (or a vehicle ECU), instead of the ECU 90.

In an example shown in FIG. 16, the first ECU 91 is electrically connected to the automatic driving control request operator 51, the second automatic driving control request operator 52, and the surrounding information detection device 60. On the other hand, the second ECU 92 is electrically connected to the displaying device 70, and the third ECU 93 is electrically connected to the driving device 20, the braking device 30, the accelerator pedal operation amount sensor 42, the brake pedal operation amount sensor 44, and the vehicle travel speed detection device 45.

Then, while the automatic cruise control is executed, the first ECU 91 provides the second ECU 92 with information on whether or not the preceding vehicle 200 is present, the target speed Vtgt, and the target distance Dtgt. Furthermore, the third ECU 93 also provides the second ECU 92 with information on the current own vehicle speed V.

While the automatic cruise control is executed, the second ECU 92 sets the upper limit speed Vupper and the lower limit speed Vlower, or the upper limit distance Dupper and the lower limit distance Dlower based on the information provided by the first ECU 91 (particularly, the information on the target speed Vtgt and the target distance Dtgt). It should be noted that in the second modified example, the control device 10 may be configured to provide the information on the upper limit speed Vupper, the lower limit speed Vlower, the upper limit distance Dupper, and the lower limit distance Dlower from the first ECU 91 to the second ECU 92.

Furthermore, while the automatic cruise control is executed, the second ECU 92 determines whether the optimal acceleration control or the coasting deceleration control is executed based on the information provided from the third ECU 93.

Then, the second ECU 92 displays the image of the target speed range RVtgt and the image of the target distance range RDtgt, etc. by the head-up display 71 and the meter display 72 based on the set upper limit speed Vupper, etc. and the determination result of whether the optimal acceleration control or the coasting deceleration control is executed as described above.

According to the second modified example, an amount of the information provided from the first ECU 91 to the second ECU 92 can be reduced, and a communication load from the first ECU 91 to the second ECU 92 can be reduced.

It should be noted that in the second modified example, when the control device 10 can determine whether the optimal acceleration control or the coasting deceleration control is executed, the control device 10 displays the image of the upper limit speed Vupper or the image of the lower limit speed Vlower, or the image of the upper limit distance Dupper or the image of the lower limit distance Dlower in a highlighted manner as described above. However, when the control device 10 cannot determine whether the optimal acceleration control or the coasting deceleration control is executed, the control device 10 does not display the image of the upper limit speed Vupper or the image of the lower limit speed Vlower, or the image of the upper limit distance Dupper or the image the lower limit distance Dlower in a highlighted manner. It should be noted that when the control device 10 cannot determine whether the optimal acceleration control or the coasting deceleration control is executed, the control device 10 may display both the image of the upper limit distance Dupper and the image of the lower limit distance Dlower in a highlighted manner by the head-up display 71. That is, the control device 10 may display both the image of the upper limit distance highlighting line LDupper_E and the image of the lower limit distance highlighting line LDlower_E by the head-up display 71.

Furthermore, the first inter-vehicle distance control is a control of controlling the acceleration and deceleration of the own vehicle 100 such that the preceding vehicle distance DF is maintained at the target distance Dtgt, and therefore is a control which targets the preceding vehicle 200, but it may also be a control which targets the following vehicle 300. In other words, the first inter-vehicle distance control may be a control of automatically controlling the acceleration and deceleration of the own vehicle 100 such that the following vehicle distance DR is maintained at the target distance Dtgt.

Similarly, the second inter-vehicle distance control is a control of controlling the acceleration and deceleration of the own vehicle 100 such that the preceding vehicle distance DF is maintained at a distance within the target distance range RDtgt, and therefore is a control which targets the preceding vehicle 200, but it may also be a control which targets the following vehicle 300. In other words, the second inter-vehicle distance control may be a control of automatically controlling the acceleration and deceleration of the own vehicle 100 such that the following vehicle distance DR is maintained within the target distance range RDtgt.

It should be noted that the preceding vehicle 200 is a vehicle traveling in front of the own vehicle 100 in the same direction as the own vehicle 100, and the following vehicle 300 is a vehicle traveling behind the own vehicle 100 in the same direction as the own vehicle 100. Therefore, the preceding vehicle 200 and the following vehicle 300 are surrounding vehicles which are present around the own vehicle 100 and travel in the same direction as the own vehicle 100.

Therefore, the first inter-vehicle distance control is a control of automatically accelerating or decelerating the own vehicle 100 such that the inter-vehicle distance between the own vehicle 100 and the surrounding vehicle is maintained at the target distance Dtgt, and the second inter-vehicle distance control is a control of automatically accelerating or decelerating the own vehicle 100 such that the inter-vehicle distance between the own vehicle 100 and the surrounding vehicle is maintained at a distance within the target distance range RDtgt.

It should be noted that the control device 10 may be configured to temporarily suspend the second automatic driving control when an interruption event occurs while the second automatic driving control is executed, such as when the own vehicle 100 travels on a curved road or when there are many other vehicles around the own vehicle 100, and to resume the second automatic driving control when the interruption event is resolved. In this case, while the second automatic driving control is temporarily suspended, the control device 10 displays images by the head-up display 71 and the meter display 72 in the same manner as while the first automatic driving control is executed.

Furthermore, the present invention can be applied to a case that the control device 10 is configured to control the own vehicle speed V with a certain control width, similar to the second travel speed control, while a specified event occurs while the first inter-vehicle distance control is executed. Furthermore, the present invention can be also applied to a case that the control device 10 is configured to control the preceding vehicle distance DF with a certain control width, similar to the second inter-vehicle distance control, while a specified event occurs while the first inter-vehicle distance control is executed.

### <Specific Operation of Control Device>

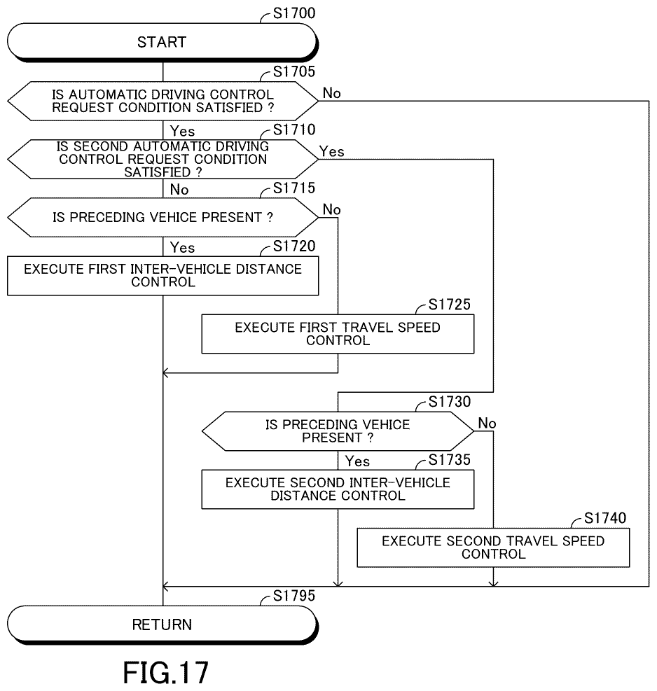

Next, a specific operation of the control device 10 will be described. The control device 10 executes a routine shown in FIG. 17 at a predetermined calculation cycle. Therefore, at a predetermined timing, the control device 10 starts a process from a step S1700 of the routine shown in FIG. 17, and proceeds with the process to a step S1705 to determine whether an automatic driving control request condition is satisfied.

When the control device 10 determines “Yes” at the step S1705, the control device 10 proceeds with the process to a step S1710 to determine whether a second automatic driving control request condition is satisfied. When the control device 10 determines “No” at the step S1710, the control device 10 proceeds with the process to a step S1715 to determine whether the preceding vehicle 200 is present. When the control device 10 determines “Yes” at the step S1715, the control device 10 proceeds with the process to a step S1720 to execute the first inter-vehicle distance control. Next, the control device 10 proceeds with the process to a step S1795 and terminates the process of this routine once.

On the other hand, when the control device 10 determines “No” at the step S1715, the control device 10 proceeds with the process to a step S1725 to execute the first travel speed control. Next, the control device 10 proceeds with the process to the step S1795 and terminates the process of this routine once.

Furthermore, when the control device 10 determines “Yes” at the step S1710, the control device 10 proceeds with the process to a step S1730 to determine whether or not the preceding vehicle 200 is present. When the control device 10 determines “Yes” at the step S1730, the control device 10 proceeds with the process to a step S1735 to execute the second inter-vehicle distance control. Next, the control device 10 proceeds with the process to the step S1795 and terminates the process of this routine once.

On the other hand, when the control device 10 determines “No” at the step S1730, the control device 10 proceeds with the process to a step S1740 to execute the second travel speed control. Next, the control device 10 proceeds with the process to the step S1795 and terminates the process of this routine once.

Furthermore, when the control device 10 determines “No” at the step S1705, the control device 10 proceeds with the process directly to the step S1795 and terminates the process of this routine once.

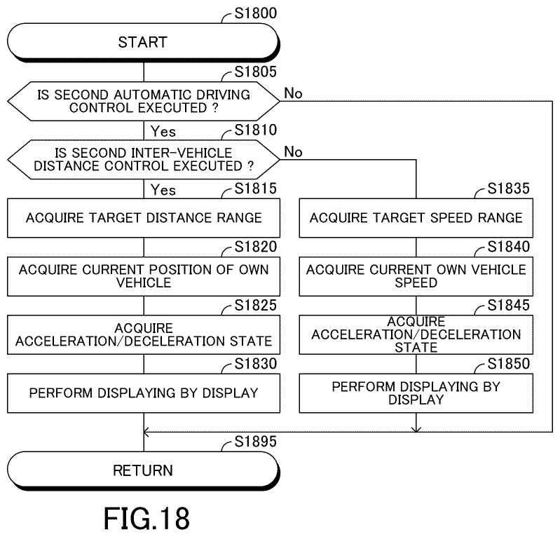

Furthermore, the control device 10 executes a routine shown in FIG. 18 at a predetermined calculation cycle. Therefore, at a predetermined timing, the control device 10 starts a process from a step S1800 of the routine shown in FIG. 18, and proceeds with the process to a step S1805 to determine whether the second automatic driving control is executed. When the control device 10 determines “Yes” at the step S1805, the control device 10 proceeds with the process to a step S1810 to determine whether or not the second inter-vehicle distance control is executed.

When the control device 10 determines “Yes” at the step S1810, the control device 10 proceeds with the process to a step S1815 to acquire the target distance range RDtgt. Next, the control device 10 proceeds with the process to a step S1820 to acquire a current position of the own vehicle 100 relative to the preceding vehicle 200. Next, the control device 10 proceeds with the process to a step S1825 to acquire the acceleration/deceleration state of the own vehicle 100. That is, the control device 10 acquires whether the optimal acceleration control or the coasting deceleration control is executed. Next, the control device 10 proceeds with the process to a step S1830 to display the images of the control-related information such as the target distance range RDtgt by the head-up display 71 and the meter display 72 as described above based on “the acquired target distance range RDtgt, the acquired current position of the own vehicle 100 relative to the preceding vehicle 200, and the acquired acceleration/deceleration state of the own vehicle 100”. Next, the control device 10 proceeds with the process to a step S1895 and terminates the process of this routine once.

On the other hand, when the control device 10 determines “No” at the step S1810, the control device 10 proceeds with the process to a step S1835 to acquire the target speed range RVtgt. Next, the control device 10 proceeds with the process to a step S1840 to acquire the current own vehicle speed V. Next, the control device 10 proceeds with the process to a step S1845 to acquire the acceleration/deceleration state of the own vehicle 100. That is, the control device 10 acquires whether the optimal acceleration control or the coasting deceleration control is executed. Next, the control device 10 proceeds with the process to a step S1850 to display the images of the control-related information such as the target speed range RVtgt by the head-up display 71 and the meter display 72 as described above based on “the acquired target speed range RVtgt, the acquired current own vehicle speed V, and the acquired acceleration/deceleration state of the own vehicle 100”. Next, the control device 10 proceeds with the process to the step S1895 and terminates the process of this routine once.

The above is the specific operation of the control device 10.

### REFERENCE SIGNS LIST

10 . . . Control Device (Displaying Control Device), 20 . . . Driving Device, 30 . . . Braking Device, 70 . . . Displaying Device, 71 . . . Head-up Display, 72 . . . Meter display, 90 . . . ECU, 100 . . . Own Vehicle, 200 . . . Preceding Vehicle, 300 . . . Following Vehicle, RVtgt . . . Target Speed Range, BRI . . . Target Speed Range Bar, Vupper . . . Upper Limit Speed, Vlower . . . Lower Limit Speed, RDtgt . . . Target Distance Range, Dupper . . . Upper Limit Distance, Dlower . . . Lower Limit Distance, LDupper . . . Upper Limit Distance Line, LDlower . . . Lower Limit Distance Line, LDupper_E . . . Upper Limit Distance Highlighting Line, LDlower_E . . . Lower Limit Distance Highlighting Line

1. A displaying control device comprising an electronic control unit,
wherein the electronic control unit is configured to:
display an image of a target speed range by a displaying device of an own vehicle while a travel speed control is executed to automatically accelerate or decelerate the own vehicle such that a travel speed of the own vehicle is maintained within the target speed range; or
display an image of a target distance range by the displaying device while an inter-vehicle distance control is executed to automatically accelerate or decelerate the own vehicle such that an inter-vehicle distance between the own vehicle and a surrounding vehicle which is present around the own vehicle and travels in the same direction as the own vehicle is maintained within the target distance range.

2. The displaying control device according to claim 1, wherein
the target distance range is a range defined by an upper limit value which is greater than a target distance by a first value, which target distance is a value obtained by multiplying a target value of the time required for the own vehicle to travel the inter-vehicle distance at the travel speed of the own vehicle, and a lower limit value which is smaller than the target distance by a second value.

3. The displaying control device according to claim 1, wherein while the travel speed control is executed, the electronic control unit is configured to display, as the image of the target speed range by the displaying device, an image of a movement range of the own vehicle automatically accelerated or decelerated such that the travel speed of the own vehicle is maintained at a speed within the target speed range.

4. The displaying control device according to claim 1, wherein while the travel speed control is executed, the electronic control unit is configured to display, as the image of the target speed range by the displaying device, an image of an upper limit speed and an image of a lower limit speed of the target speed range.

5. The displaying control device according to claim 4, wherein when the own vehicle is accelerated by the travel speed control, the electronic control unit is configured to display, by the displaying device, the image of the upper limit speed and the image of the lower limit speed such that the image of the upper limit speed is highlighted more than the image of the lower limit speed.

6. The displaying control device according to claim 4, wherein when the own vehicle is decelerated by the travel speed control, the electronic control unit is configured to display, by the displaying device, the image of the upper limit speed and the image of the lower limit speed such that the image of the lower limit speed is highlighted more than the image of the upper limit speed.

7. The displaying control device according to claim 1, wherein the travel speed control is a control of accelerating the own vehicle by operating a driving device of the own vehicle such that an energy efficiency of the driving device is maintained at or above a predetermined efficiency, and decelerating the own vehicle by operating the driving device such that the own vehicle coasts.

8. The displaying control device according to claim 1, wherein while the inter-vehicle distance control is executed, the electronic control unit is configured to display, as the image of the target distance range by the displaying device, an image of an upper limit distance and an image of a lower limit distance of the target distance range.

9. The displaying control device according to claim 8, wherein when the own vehicle is accelerated by the inter-vehicle distance control, the electronic control unit is configured to display the image of the upper limit distance and the image of the lower limit distance by the displaying device such that the image of the lower limit distance is highlighted more than the image of the upper limit distance.

10. The displaying control device according to claim 8, wherein when the own vehicle is decelerated by the inter-vehicle distance control, the electronic control unit is configured to display the image of the upper limit distance and the image of the lower limit distance by the displaying device such that the image of the upper limit distance is highlighted more than the image of the lower limit distance.

11. The displaying control device according to claim 1, wherein
the inter-vehicle distance control is a control of accelerating the own vehicle by operating an driving device of the own vehicle such that an energy efficiency of the driving device is maintained at or above a predetermined efficiency, and decelerating the own vehicle by controlling an operation of the driving device such that the own vehicle coasts.

12. The displaying control device according to claim 1, wherein the electronic control unit is configured to display, by the displaying device, an image of a current travel speed of the own vehicle on the image of the target speed range displayed by the displaying device while the travel speed control is executed, and display, by the displaying device, an image of the surrounding vehicle on the image of the target distance range displayed by the displaying device while the inter-vehicle distance control is executed.

13. The displaying control device according to claim 12, wherein while the inter-vehicle distance control is executed, the electronic control unit is configured to display, by the displaying device, the image of the surrounding vehicle such that a position of the image of the surrounding vehicle corresponds to an actual position of the surrounding vehicle relative to the own vehicle on the image of the target distance range displayed by the displaying device.

14. The displaying control device according to claim 1,
wherein the displaying device is a device which displays images on a windshield of the own vehicle, and
wherein when the surrounding vehicle is a preceding vehicle traveling in front of the own vehicle, the electronic control unit is configured to display the image of the target distance range on the windshield by the displaying device such that a positional relationship between the image of the target distance range displayed by the displaying device and the preceding vehicle corresponds to an actual positional relationship between the target distance range and the preceding vehicle while the inter-vehicle distance control is executed.

15. The displaying control device according to claim 1, wherein the electronic control unit is configured to:
when the own vehicle is accelerated by the travel speed control, display an image of an upper limit speed and an image of a lower limit speed by the displaying device such that the image of the upper limit speed is highlighted more than the image of the lower limit speed;
when the own vehicle is decelerated by the travel speed control, display the image of the upper limit speed and the image of the lower limit speed by the displaying device such that the image of the lower limit speed is highlighted more than the image of the upper limit speed;
when the own vehicle is accelerated by the inter-vehicle distance control, display an image of an upper limit distance and an image of a lower limit distance by the displaying device such that the image of the lower limit distance is highlighted more than the image of the upper limit distance;
when the own vehicle is decelerated by the inter-vehicle distance control, display the image of the upper limit distance and the image of the lower limit distance by the displaying device such that the image of the upper limit distance is highlighted more than the image of the lower limit distance;
when the displaying control device cannot determine whether the own vehicle is accelerated or decelerated while the travel speed control is executed, not highlight the image of the upper limit speed nor the image of the lower limit speed; and
when the displaying control device cannot determine whether the own vehicle is accelerated or decelerated while the inter-vehicle distance control is executed, not highlight the image of the upper limit distance nor the image of the lower limit distance.

16. The displaying control device according to claim 1, wherein the target speed range and the target distance range can be changed by an operator of the own vehicle.
